(19) United States
(12) Patent Application Publication
(10) Pub. No.: US 2026/0289635 A1
(43) Pub. Date: Sep. 24, 2026

(54) SYSTEM

(71) Applicant: SoftBank Group Corp., Tokyo (JP)

(72) Inventor: Nariaki MITSUO, Tokyo (JP)

(73) Assignee: SoftBank Group Corp., Tokyo (JP)

(21) Appl. No.: 19/564,216

(22) Filed: Mar. 12, 2026

(30) Foreign Application Priority Data
Mar. 19, 2025 (JP) 2025-044962

(51) Int. Cl. G06Q 30/0601; G06F 40/295; G06N 3/0475

(52) U.S. Cl. CPC G06Q 30/0631; G06F 40/295; G06N 3/0475

(57) ABSTRACT

A system includes a processor that is configured to: provide an interface for receiving an order from a user, analyze the received order using natural language processing to determine an intention of the order, and generate a prompt sentence for instructing a generative AI model to generate a cooking recipe based on an analysis result of the order.

### CROSS-REFERENCE TO RELATED APPLICATION

This application is based on and claims priority under 35 USC 119 from Japanese Patent Application No. 2025-044962 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional recipe recommendation systems generally rely on predefined recipe databases and simple keyword matching, and therefore cannot adequately interpret a user's free-form natural language order, such as a mood, a vague intention, or a contextual constraint like available ingredients in a refrigerator. As a result, such systems often fail to provide recipes that accurately reflect the user's true intention, for example, creative dishes tailored to a specific feeling, arrangements of existing dishes, or recipes that consider ingredient shortages and propose realistic substitutions. In addition, even when generative AI models are used, there is a problem that these models are not effectively guided: if an appropriate prompt is not generated based on a precise understanding of the user's intention and the real-world constraints, the output of the generative AI model may be irrelevant, impractical, or inconsistent in quality. Therefore, there is a need for a system that is capable of receiving a user's order in natural language, analyzing the order to determine the user's intention by natural language processing, and automatically generating suitable prompt sentences that instruct a generative AI model to generate cooking recipes, arrangement recipes, and substitution proposals in a manner that reflects the user's needs and constraints.

### SUMMARY

In order to solve the above-described problems, according to one aspect of the present invention, there is provided a system comprising a processor, wherein the processor is configured to provide an interface for receiving an order from a user, analyze the received order using natural language processing to determine an intention of the order, and generate a prompt sentence for instructing a generative AI model to generate a cooking recipe based on an analysis result of the order. The processor may further be configured to generate a prompt sentence for instructing the generative AI model to generate an arrangement recipe for arranging an existing dish in response to an order indicating that the user desires an arrangement of a known dish. The processor may still further be configured to acquire ingredient information of a refrigerator, identify missing ingredients based on the ingredient information, and generate a prompt sentence for instructing the generative AI model to propose substitution candidates for the missing ingredients. By integrating these functions, the system interprets complex and vague user orders, converts the interpreted intention and contextual information, including available ingredients and shortages, into structured and optimized prompt sentences, and thereby enables the generative AI model to output cooking recipes, arrangement recipes, and substitution proposals that are highly consistent with the user's intention and practical constraints.

The term “system” refers to an apparatus including at least one processor and, optionally, one or more memory units, input/output devices, communication interfaces, and software modules, which cooperate to perform the functions described in the present specification and claims.

The term “processor” refers to any hardware component or combination of hardware components, such as a central processing unit (CPU), a graphics processing unit (GPU), a digital signal processor (DSP), a microcontroller, or a dedicated logic circuit, that executes instructions to implement the functions specified in the present specification and claims.

The term “interface” refers to a hardware and/or software component that enables a user to input information, such as an order, into the system and to receive output from the system, including but not limited to a graphical user interface, a web interface, a mobile application interface, a voice interface, or an application programming interface.

The term “order” refers to information input by a user, expressed in natural language or another form, indicating at least one requirement related to cooking, such as a desired dish, a cuisine, a cooking style, an arrangement of an existing dish, ingredient constraints, or flavor preferences.

The term “natural language processing” refers to a set of computational techniques and algorithms for analyzing, interpreting, and processing human language text, including but not limited to tokenization, part-of-speech tagging, syntactic parsing, semantic analysis, and intent detection, in order to extract the intention and relevant parameters from the user's order.

The term “intention of the order” refers to a semantic representation of what the user wants to achieve by the order, such as generating a new recipe, arranging an existing dish, proposing substitutions for missing ingredients, or satisfying specific constraints related to taste, ingredients, or cooking methods.

The term “analysis result of the order” refers to structured data obtained by applying natural language processing to the user's order, the structured data including at least one of an identified intention, identified dish names, ingredient information, constraints, preferences, and contextual information used for generating a prompt sentence.

The term “generative AI model” refers to a machine learning model, such as a large language model or other generative model, that is capable of generating textual content including cooking recipes, arrangement recipes, and substitution proposals in response to a given prompt sentence.

The term “prompt sentence” refers to text data generated by the processor that specifies instructions, constraints, and contextual information to be provided as an input to the generative AI model so as to cause the generative AI model to generate an output, such as a cooking recipe, in accordance with the user's order and the analysis result of the order.

The term “cooking recipe” refers to structured information describing at least ingredients and cooking steps for preparing a dish, optionally including quantities, cooking times, temperatures, and seasoning details, generated by the generative AI model in response to the prompt sentence.

The term “arrangement recipe” refers to a cooking recipe that is generated based on an existing dish and that modifies at least one aspect of the existing dish, such as ingredients, seasoning, preparation steps, or presentation style, in order to create a variation or customized version of the existing dish.

The term “existing dish” refers to a known recipe or dish specified directly or indirectly in the user's order, such as a standard menu item, a well-known recipe name, or a dish previously stored or referenced in the system.

The term “ingredient information of a refrigerator” refers to data indicating what ingredients are currently available in at least one storage location such as a refrigerator, freezer, or pantry, the data including at least ingredient names and optionally quantities, freshness, or expiration dates.

The term “missing ingredients” refers to ingredients that are required or recommended for a cooking recipe or an arrangement recipe but are not included in the ingredient information of the refrigerator or are determined to be unavailable based on the ingredient information.

The term “substitution candidates” refers to one or more alternative ingredients proposed for replacing missing ingredients, the alternatives being selected such that they are capable of providing similar or acceptable taste, texture, or function in the cooking recipe or arrangement recipe.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

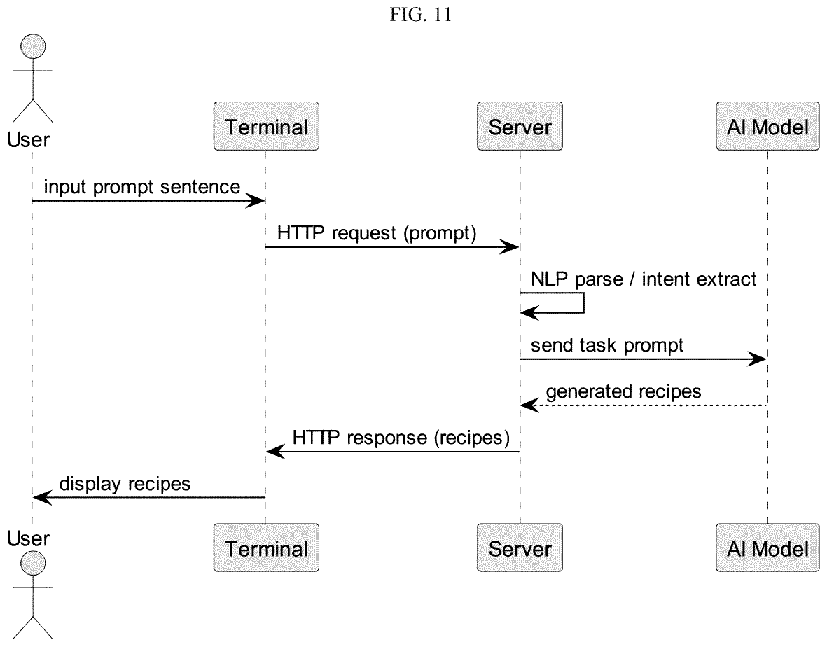

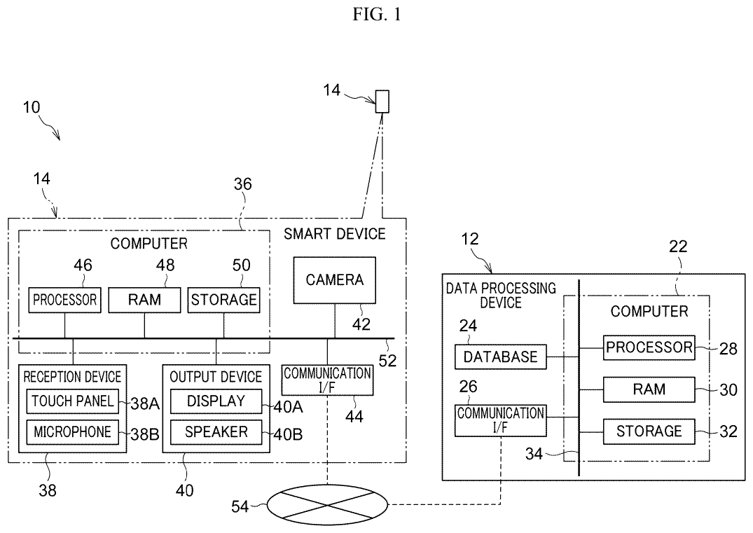

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

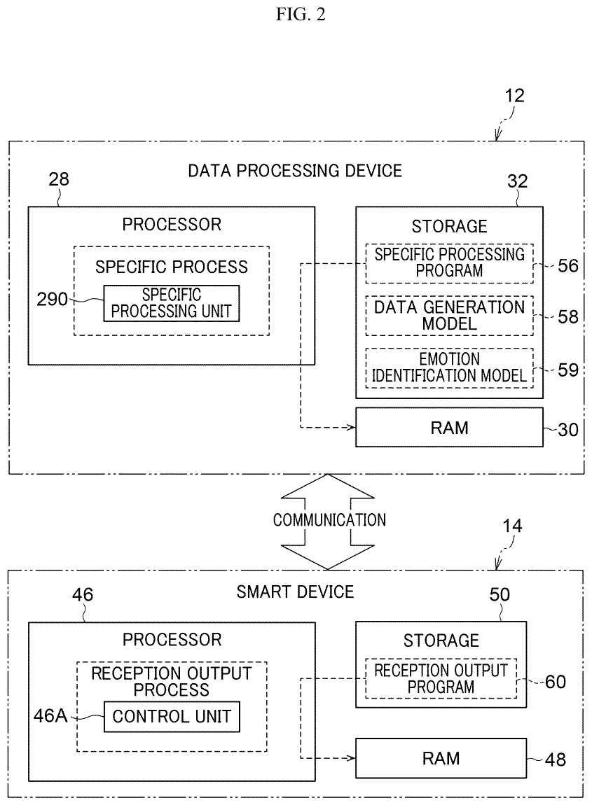

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented recipe recommendation systems mainly rely on predefined rule sets, manually curated keyword dictionaries, or fixed template matching to interpret user requests. Such architectures have several technical limitations. First, when a user inputs a prompt sentence in natural language, for example with vague or combined conditions about taste preference, available ingredients, preparation time, or meal category, conventional systems often fail to accurately extract the underlying intent because they lack robust syntactic and semantic analysis mechanisms. As a result, the internal data representation used by the processor is coarse, and the quality of the generated recipe suggestions deteriorates, leading to repeated user interactions and increased processing overhead.

Second, even when an external generative AI model is used, many existing systems simply forward the raw user input to the model. Without structured pre-processing and targeted prompt construction, the generative AI model may produce verbose, inconsistent, or irrelevant outputs. This causes unnecessary network traffic, increased computational load on the model side, and additional post-processing on the server side, thereby degrading overall system performance and responsiveness.

Third, conventional systems do not provide an integrated technical framework for dynamically constructing prompt sentences to direct the generative AI model toward specific computational tasks, such as generating an arrangement recipe for an existing dish or proposing substitute ingredients based on actual inventory. In many cases, logic for such tasks is scattered between client-side code and server-side business rules, resulting in duplicated processing, complex maintenance, and reduced scalability.

Fourth, structured consumption of model output is often insufficient. Many systems treat the generated text as an opaque result and rely on ad hoc string manipulation at the terminal, which complicates rendering, filtering, and further machine processing. The lack of a standardized transformation from model output into structured data, such as explicit dish name, ingredient list, and step-by-step instructions, limits the ability of the computer system to systematically reuse and optimize the generated content, and hinders integration with other computational components such as inventory management modules.

Therefore, there is a need for an improved computer-implemented technique in which a processor systematically: (i) analyzes a user's natural-language prompt sentence using a natural language processing method to form rich analysis data; (ii) generates, from that analysis data, specialized prompt sentences that precisely instruct a generative AI model to perform particular recipe generation tasks; (iii) communicates with the external generative AI model in a structured, task-oriented manner; and (iv) converts the model's response into structured recipe data optimized for machine processing and user presentation. Such a technique is expected to improve the efficiency, accuracy, and robustness of recipe suggestion processing, thereby constituting a concrete improvement in computer technology for natural-language-driven content generation and consumption.

The specific processing by the specific processing unit 290 of the data processing device 12 in Example 1 is realized by the following means.

The present invention provides a server comprising a processor configured to provide an information input/output unit including a display device and an input device that receives, from a user, a prompt sentence representing a request related to a cooking activity; analyze the prompt sentence by using a natural language processing method to generate analysis data by segmenting the prompt sentence into units including at least morpheme units or phrase units and identifying, based on part-of-speech information and dependency relations, at least a taste preference, a cooking target, available ingredients, time conditions, and a meal category; generate, based on the analysis data, a task-specific prompt sentence that instructs a generative AI model to generate a cooking proposal or a cooking procedure and reconstruct the task-specific prompt sentence into an input format for the generative AI model; transmit the task-specific prompt sentence to the external generative AI model and acquire, as recipe information, a cooking proposal result returned from the generative AI model; and convert the recipe information into structured data including at least a dish name, ingredient information, and step information and edit the structured data into a display format suitable for presentation to the user via the information input/output unit. This enables the server to technically improve the end-to-end processing pipeline from natural-language user input to machine-consumable recipe output, by enhancing intent extraction through structured linguistic analysis, by optimizing interaction with the generative AI model through dynamically constructed task-oriented prompt sentences, and by standardizing the transformation of generative output into structured data, thereby reducing computational overhead, improving response relevance, and increasing the robustness and scalability of computer-based recipe recommendation and generation.

The term “processor” refers to a hardware or virtual processing unit, such as a central processing unit, a graphics processing unit, or a processing core in a computing environment, that executes instructions to perform data processing operations defined by software or firmware.

The term “information input/output unit” refers to a combination of hardware and software components, including at least a display device and an input device, that enables a user to provide data to the system and to receive data presented by the system.

The term “display device” refers to an electronic visual output apparatus, such as a liquid crystal display, an organic light emitting display, or a projection display, that presents characters, images, or graphical user interfaces to a user.

The term “input device” refers to a hardware component, such as a keyboard, a pointing device, a touch panel, a microphone, or an image sensor, that allows a user to input data or commands into the system.

The term “user” refers to a human operator who interacts with the system by providing natural-language prompt sentences and by viewing or utilizing recipe information presented by the system.

The term “prompt sentence” refers to a sequence of natural-language characters or words, typically including at least one sentence, that expresses a user's request, condition, or preference related to a cooking activity.

The term “natural language processing method” refers to a computer-implemented technique that operates on natural-language text to perform at least one of tokenization, morphological analysis, part-of-speech tagging, syntactic parsing, or semantic analysis.

The term “analysis data” refers to structured internal data generated by the processor through applying a natural language processing method to a prompt sentence, the structured internal data including identified attributes such as taste preferences, cooking targets, available ingredients, time conditions, and meal categories.

The term “morpheme unit” refers to a smallest meaningful linguistic unit obtained by segmenting a prompt sentence according to a natural language processing method, such as a word, stem, or affix.

The term “phrase unit” refers to a group of one or more morpheme units that function together as a syntactic constituent, such as a noun phrase, a verb phrase, or an adjective phrase, in a prompt sentence.

The term “part-of-speech information” refers to classification information indicating grammatical categories of morpheme units or tokens, such as nouns, verbs, adjectives, adverbs, or prepositions, identified by a natural language processing method.

The term “dependency relations” refers to syntactic relationships between tokens or phrase units in a sentence, indicating which linguistic elements depend on or modify other elements, as determined by a dependency parser.

The term “taste preference” refers to an attribute extracted from a prompt sentence that indicates a desired flavor characteristic of a dish, such as spicy, sweet, salty, sour, or mild.

The term “cooking target” refers to an attribute extracted from a prompt sentence that represents an object of cooking, such as a specific dish type, a food category, or a meal style to be prepared.

The term “available ingredients” refers to ingredient items that are identified, from the prompt sentence or from external ingredient information, as currently usable for cooking by the user.

The term “time conditions” refers to constraints or preferences related to time, such as a preparation time limit or a cooking duration, extracted from a prompt sentence or other data.

The term “meal category” refers to a classification of a meal, such as breakfast, lunch, dinner, or snack, that is identified from a prompt sentence.

The term “task-specific prompt sentence” refers to a prompt sentence constructed by the processor from analysis data, which explicitly describes a computational task to be executed by a generative AI model, such as generating a cooking proposal, generating cooking steps, modifying an existing dish, or proposing substitute ingredients.

The term “generative AI model” refers to a machine-learned model, such as a generative language processing model, that receives text or token-based input and generates text or token-based output by probabilistic prediction over a learned parameter space.

The term “input format for the generative AI model” refers to a structured representation of a prompt, such as a token sequence, a message array, or a formatted text block, that conforms to a calling specification of an external inference interface of the generative AI model.

The term “external generative AI model” refers to a generative AI model that is executed on a computing system separate from the processor that performs prompt construction, the separate computing system being accessible over a communication network via an application programming interface.

The term “cooking proposal” refers to content generated by a generative AI model that includes at least an indication of a dish or cooking idea satisfying conditions specified by analysis data.

The term “cooking procedure” refers to a sequence of cooking steps or instructions, expressed in natural language or structured form, that guides preparation of a dish.

The term “recipe information” refers to data obtained from a generative AI model representing at least one of a cooking proposal, a dish name, an ingredient list, and a set of cooking steps.

The term “structured data” refers to data organized according to a predefined schema or data structure, including at least explicit fields for a dish name, ingredient information, and step information, suitable for machine processing and presentation.

The term “dish name” refers to a textual label that identifies a particular prepared food item or recipe generated or selected by the system.

The term “ingredient information” refers to structured data representing components used in cooking a dish, such as ingredient names, quantities, and optionally preparation details.

The term “step information” refers to structured data representing an ordered sequence of actions to be taken to cook a dish, each action typically being expressed as a step in a recipe.

The term “display format” refers to a layout or representation of structured data that is formatted for presentation on a display device, including arrangement, ordering, and styling suitable for user comprehension.

The term “existing dish name” refers to a name of a known dish or recipe that is explicitly or implicitly included in a prompt sentence and that serves as a base for generating an arrangement recipe.

The term “modification conditions” refers to one or more constraints or requests extracted from a prompt sentence that indicate how an existing dish should be changed, such as changing ingredients, taste, cooking time, or dietary properties.

The term “arrangement recipe” refers to a recipe derived by applying one or more modification conditions to an existing dish, resulting in a modified set of ingredients, steps, or characteristics.

The term “storage device” refers to a hardware component, such as a semiconductor memory, a magnetic storage medium, or an optical storage medium, that stores ingredient information or other data used by the processor.

The term “external device” refers to a computing apparatus other than the server, such as a home appliance, a mobile terminal, or a remote server, that provides ingredient information or related data to the processor via a communication interface.

The term “ingredient information” (in the context of storage or external acquisition) refers to data indicating at least the type and optionally the quantity, freshness, or availability status of ingredients managed by an inventory system or another data source.

The term “missing ingredient” refers to an ingredient that is required or desirable for a dish based on analysis data but is absent or insufficient in the available ingredients identified from ingredient information.

The term “substitute candidate” refers to an ingredient or combination of ingredients proposed as a replacement for a missing ingredient, based on compatibility with the target dish and constraints included in analysis data.

The term “substitute recipe” refers to a recipe that is modified relative to an original recipe such that one or more missing ingredients are replaced by substitute candidates or omitted while maintaining feasibility and coherence of the dish.

The term “communication network” refers to a wired or wireless data transmission infrastructure, including at least one of the Internet, a local area network, or a cellular network, used to exchange data between the processor and the external generative AI model or an external device.

The term “application programming interface” refers to a specification, including at least an endpoint, a request format, and a response format, that defines how software components communicate and exchange data, particularly between the processor and an external generative AI model.

In one embodiment, a server, a terminal, and a communication network together implement a system that generates structured recipe information based on a user's natural-language prompt sentence and a generative AI model.

The server includes at least one processor, a main memory, a non-volatile storage device, and a network interface. The processor executes program modules stored in the non-volatile storage device and loaded into the main memory. The non-volatile storage device may be implemented as a solid-state drive or a magnetic disk device. The network interface connects the server to an external network such as the Internet. The server further uses a web server component, such as a reverse proxy process, and an application framework, such as a web application framework written in a general-purpose programming language (for example, Python with a web framework or JavaScript with a web framework), to handle requests from the terminal.

The terminal includes at least one processor, a display device, an input device, a memory, and a communication module. The terminal may be implemented as a smartphone, a tablet computer, or a personal computer. The terminal executes an application program, such as a web browser or a native application, which displays a graphical user interface provided by the server or locally stored interface definitions. The terminal connects to the server over the communication network using a communication protocol such as HTTPS.

The user operates the terminal to input a prompt sentence in natural language. The terminal displays a text input area, such as a text box, and a control element, such as a send button. The user enters the prompt sentence through the input device. The prompt sentence may include requests such as:

“I want to eat something spicy today.”

“I have tomatoes and cheese in my fridge; what can I make?”

“I want a vegan and spicy soup that I can cook in under 20 minutes.”

The terminal transmits the prompt sentence to the server via the communication module using an HTTP request.

The server receives the HTTP request at the web server component and forwards it to the application layer. The server parses the request, extracts the prompt sentence, and stores it in memory. The server then invokes a natural language processing module executed by the processor. The natural language processing module uses a general-purpose natural language processing library such as a tokenization and parsing library and a dependency parsing library. The server loads a language model for text analysis, such as an English model, into memory at startup, thereby reducing repeated loading overhead.

The server applies tokenization to the prompt sentence to obtain a sequence of tokens, each token corresponding to a morpheme unit or a word-like unit. The server then applies part-of-speech tagging to assign a syntactic category to each token, such as noun, verb, adjective, or adverb. The server further applies dependency parsing to compute dependency relations between tokens, thereby forming a syntactic tree. The server additionally executes named entity recognition to extract mentions of food items, quantities, times, and meal categories. In one embodiment, the server constructs a feature vector for each token that includes at least the token string, part-of-speech tag, dependency relation type, and entity label. The server uses these feature vectors to classify semantic roles, such as taste preference, cooking target, available ingredient, time condition, and meal category.

The server groups tokens and entities into phrase units corresponding to noun phrases or verb phrases. The server uses a rule-based classifier that operates on the parsed tree structure. For example, the server identifies adjectives modifying food-related nouns as candidate taste preferences and identifies time expressions attached to verbs associated with cooking actions as time conditions. The server stores the analysis result as analysis data, which may be represented as a structured record including fields such as:
(a) a list of identified ingredients;
(b) a list of taste preferences, e.g., “spicy”;
(c) a time constraint, e.g., “under 20 minutes”;
(d) a meal category, e.g., “dinner”;
(e) one or more cooking targets, e.g., “soup” or “pasta”.

The server thereby transforms unstructured text into a structured internal representation suitable for downstream processing.

The server then executes a prompt construction module. The prompt construction module uses the analysis data to generate a task-specific prompt sentence for a generative AI model. The generative AI model may be a large-scale neural network for natural language generation, such as a transformer-based language model with multiple self-attention layers, feedforward layers, and layer normalization. The server stores in memory a prompt template that defines a system role and required output format. The server inserts the analysis data into the template to generate a complete prompt sentence.

For example, when the user inputs the prompt sentence “I have tomatoes and cheese in my fridge; what can I make?”, the server may generate the following task-specific prompt sentence for the generative AI model:

“The user's original prompt sentence is: ‘I have tomatoes and cheese in my fridge; what can I make?’

Identified ingredients: tomatoes, cheese.

You are a cooking assistant. Using these ingredients, propose 2-3 recipes.

For each recipe, provide:
1. A short title.
2. A list of ingredients.
3. Step-by-step cooking instructions.”

Similarly, when the user inputs “I want to eat something spicy today.”, the server may generate:

“The user wants to eat something spicy today.

You are a cooking assistant. Suggest 3 dinner recipes that are spicy and easy to cook.

For each recipe, provide a title, an ingredient list, and step-by-step instructions.”

The server structures the task-specific prompt in an input format required by the generative AI model. In one embodiment, the server forms a message array consisting of a system message indicating the overall role of the model and a user message containing the constructed prompt text. The server sends this structured prompt to the external generative AI model through an application programming interface over HTTPS using the network interface of the server.

The generative AI model may be deployed on a separate computing platform, such as a cluster of servers. The generative AI model is typically a transformer architecture with an encoder-decoder or decoder-only structure, multiple attention heads, multi-layer feedforward networks, and parameters trained on a large corpus of text data. During training, the model minimizes a loss function such as cross-entropy between predicted token distributions and ground truth tokens. The training process updates model parameters using an optimization algorithm such as stochastic gradient descent or a variant thereof. The model learns patterns in natural language and relationships between ingredients, cooking methods, and recipe structures.

During inference, the server's prompt sentence is tokenized into a sequence of token identifiers and embedded into continuous vectors. The generative AI model propagates these vectors through attention layers that compute weighted sums of representations across positions, enabling the model to attend to relevant context. The model then produces, at each step, a probability distribution over possible next tokens. A decoding algorithm such as greedy decoding, beam search, or top-k sampling selects output tokens to form a generated response. The server does not train the model during normal operation but uses it in inference mode. The server may specify parameters such as temperature, maximum output length, and top-p threshold to control the diversity and length of generated recipes.

The server receives the generated response from the generative AI model through the network interface. The response typically contains one or more recipes described in natural language text. The server passes this text to a post-processing module executed by the processor. The post-processing module applies text segmentation and pattern recognition to separate individual recipes, titles, ingredient sections, and instruction sections. The server may use simple delimiters such as numbered lists (“1.”, “2.”) or keywords (“Ingredients:”, “Instructions:”), as well as regular expressions, to extract structured components.

The server converts the generated text into structured recipe information, such as records each having a dish name, an ingredient list, and a sequence of steps. The server may normalize ingredient names by mapping synonyms to canonical labels and may assign internal identifiers to ingredients, which facilitates integration with an inventory management module. The server stores the structured recipe information in memory in a format suitable for efficient search and retrieval, such as a list of objects or records.

The server then edits the structured recipe information into a display format. The server may generate a markup representation that includes headings, bullet lists, and numbered steps. The server transmits the formatted data to the terminal through the network interface as an HTTP response. The terminal receives the response and converts it into displayable content. The terminal renders, on the display device, a list of generated recipes. The user can select a particular recipe to view detailed ingredients and step-by-step instructions. The user may use the terminal near a cooking area, and the terminal may display the recipe with larger fonts and appropriate layout to facilitate easy reading while cooking.

The described configuration improves computer technology in several ways. The server performs structured linguistic analysis of the prompt sentence before interacting with the generative AI model. This analysis reduces ambiguity and noise in the input, which allows the server to construct more precise task-specific prompts. As a result, the generative AI model produces outputs that are more aligned with the user's intent. This alignment reduces the need to repeat generation calls, thereby decreasing network load between the server and the external model and reducing computational load on the external model infrastructure. The server further converts model output into a structured internal representation rather than simply passing text to the terminal. This structured representation enables efficient indexing, filtering, and reuse of recipe data. For example, the server may later identify recipes containing a particular ingredient or satisfying a time constraint without re-invoking the generative AI model. This design improves data management efficiency and reduces redundant computation.

The combination of rule-based parsing and generative modeling also provides a technical improvement over simple keyword search. The server's parser uses dependency relations and part-of-speech information to capture relationships between tokens in a way that is independent of superficial word order. For example, the server can correctly interpret both “I want a quick spicy dinner” and “For dinner, I want something spicy and quick” as expressing the same combination of taste preference and time condition. This robust parsing improves the accuracy of intent extraction and reduces misinterpretations, which in turn reduces error rates in recipe proposals.

The architecture also improves computational efficiency. By extracting key attributes such as ingredients and constraints, the server can include only relevant information in the task-specific prompt sentence sent to the generative AI model. This reduces prompt length and, therefore, reduces the number of tokens processed by the generative AI model, which directly lowers processing time and resource usage. The server may also cache analysis data and results for frequently occurring patterns of prompt sentences, further reducing latency.

The server executes algorithms that differ from human manual processing. A human chef reading a request would not explicitly compute part-of-speech tags or dependency graphs, nor would the chef encode the request into a token sequence optimized for a transformer decoder. Instead, the server applies non-intuitive, machine-oriented procedures, including vector-based token representations, attention-based context aggregation, and large-scale parameterized transformations that are not feasible for a human to compute in real time. Thus, the system's behavior is not a mere automation of human conceptual reasoning but a specific exploitation of computational structures.

In another embodiment, the server supports variant tasks such as generating an arrangement recipe for an existing dish. The user may input a prompt sentence such as:

“Please make a healthier version of carbonara with less fat.”

The server's natural language processing module extracts an existing dish name (“carbonara”) and modification conditions (“healthier”, “less fat”). The server includes these attributes in the analysis data, then constructs a task-specific prompt sentence instructing the generative AI model to modify an existing recipe according to the conditions. The generative AI model generates an arrangement recipe with modified ingredients and steps, which the server parses and structures in the same manner as for new recipe generation. This specialization of prompts improves the precision of the generative model output and reduces the need for manual filtering or editing.

In another embodiment, the server acquires ingredient information from a storage device or an external device such as a refrigerator equipped with a communication function. The external device periodically transmits stored ingredient information, including item types and quantities, to the server. When the user inputs a prompt sentence such as:

“I want to cook pasta tonight with what I have in the fridge.”

the server combines the prompt sentence and the stored ingredient information in the analysis data. The server identifies missing ingredients by comparing required ingredients inferred from the text with the inventory data. The server then constructs a task-specific prompt sentence requesting that the generative AI model propose substitute candidates or substitute recipes that avoid the missing ingredients. This combination of inventory information and text analysis enables the server to control the generative AI model in a way that reduces user trial-and-error and optimizes the use of available ingredients.

The generative AI model itself can be trained using a dataset comprising recipes, ingredient lists, and natural-language descriptions of cooking preferences. The training process may augment data by paraphrasing instructions, varying ingredient names, or introducing synthetic variations in style. The model learns to map from structured task descriptions and constraints to coherent recipes. The server uses a pre-trained instance of this model and, optionally, fine-tunes it for recipe-related tasks. The server may adapt the model parameters using gradient-based optimization on a smaller domain-specific dataset. The loss function may incorporate penalties for violating constraints such as ingredient availability or dietary restrictions, thereby biasing the model outputs toward feasible recipes.

In a further embodiment, the server can implement different decoding strategies depending on the analysis data. For example, when the time condition is strict (“under 10 minutes”), the server can instruct the generative AI model via the task-specific prompt and decoding parameters to favor shorter recipes and fewer steps. When the user requests variety, the server can set a higher temperature or sampling radius in the decoding algorithm to increase diversity of generated recipes. Such parameter control is based on structured analysis of the prompt sentence and is not merely a direct reflection of user text, thereby constituting a specific technical strategy for managing generative behavior.

The described system is applicable not only to recipe generation for human consumption but also to control or guidance of kitchen-related equipment. In one variation, the server outputs structured step information that includes machine-readable tags indicating heating time, temperature, and equipment type. The terminal may transmit these tags to a controllable cooking device, such as a programmable oven, which automatically sets appropriate parameters. Because the server normalizes step information into structured data, the server can map generative descriptions into concrete numerical parameters for equipment control, enabling technical integration between the generative AI model output and physical device settings.

Through these embodiments, the server, terminal, and generative AI model cooperate to form a system that not only interprets natural-language prompt sentences and generates recipe text but also improves the underlying computer processing pipeline. The system reduces ambiguity in user input via syntactic and semantic analysis, optimizes interactions with a generative AI model through tailored prompt sentences, and structures generative output for efficient re-use and integration, thereby providing concrete improvements in accuracy, speed, computational efficiency, and robustness of computer-implemented recipe generation.

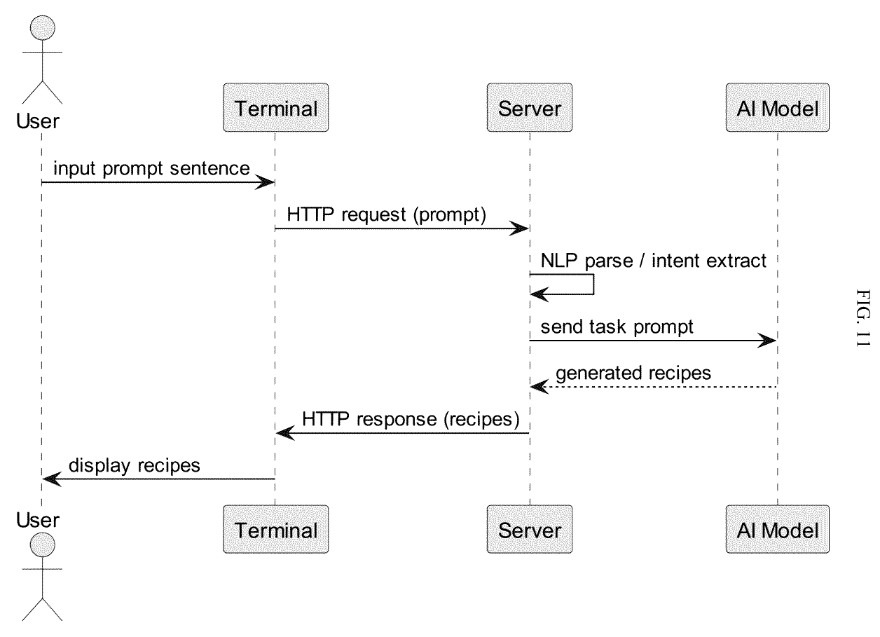

The following describes the processing flow using FIG. 11.

### Step 1

The terminal displays a user interface including a text input field and a send button on the display device.

The user inputs a prompt sentence, such as “I want to eat something spicy today.”, by operating the input device of the terminal.

The terminal receives the prompt sentence as input, encapsulates it into an internal data object, and prepares it as the payload for transmission to the server.

The terminal outputs an HTTP request including the prompt sentence and sends the request to the server over a network using a communication module.

### Step 2

The server receives the HTTP request containing the prompt sentence via a network interface and a web server component.

The server parses the HTTP headers and body to extract the prompt sentence as input data.

The server performs basic validation on the prompt sentence, such as checking that the string is not empty and that its length is within a predefined range.

The server outputs a validated text string representing the prompt sentence and stores it in working memory for subsequent natural language processing.

### Step 3

The server uses a natural language processing library to tokenize the validated prompt sentence into a sequence of tokens as input.

The server applies part-of-speech tagging and dependency parsing algorithms to each token to compute syntactic structures, such as grammatical roles and dependency relations.

The server performs named entity recognition to detect ingredients, time expressions, and other domain-relevant entities embedded in the prompt sentence.

The server outputs analysis data, which includes a token list, part-of-speech information, dependency tree structures, and recognized entities, and stores this data in a structured internal representation.

### Step 4

The server receives the analysis data as input and executes a semantic interpretation module that maps syntactic features to domain-specific attributes.

The server applies rule-based logic that operates on part-of-speech tags and dependency relations to identify taste preferences, cooking targets, available ingredients, time conditions, and meal categories.

The server aggregates the identified attributes into a structured record, such as a dictionary or object with predefined fields, and resolves conflicts or duplicates using prioritization rules.

The server outputs a consolidated intent representation, which includes fields like ingredient list, flavor preferences, time constraints, and meal type, for use in prompt construction.

### Step 5

The server uses the consolidated intent representation as input to a prompt construction module.

The server selects a prompt template corresponding to the desired task, such as new recipe generation, arrangement recipe generation, or substitute ingredient proposal.

The server inserts the extracted attributes, including ingredients, taste preferences, and time conditions, into the selected template to construct a task-specific prompt sentence for the generative AI model.

The server formats the constructed prompt sentence into an input format required by the generative AI model, such as a message array with system and user roles, and outputs a structured prompt package ready for transmission.

### Step 6

The server takes the structured prompt package as input and initiates a request to an external generative AI model via an application programming interface.

The server serializes the prompt into a JSON request, sets parameters such as model name, maximum token count, and temperature, and includes authentication information.

The server transmits the request over a secure channel, waits for a response, and handles potential network errors or timeouts by applying retry or fallback procedures.

The server outputs a raw model response, typically a text block containing one or more recipe descriptions, and stores it for post-processing.

### Step 7

The server receives the raw model response text as input to a post-processing module.

The server applies text segmentation techniques, such as splitting by headings, numbered lists, or specific keywords, to separate individual recipes.

The server parses each recipe segment to extract a dish name, an ingredient section, and a step-by-step instruction section by using pattern matching and regular expressions.

The server outputs structured recipe data for each recipe, including explicit fields for dish name, ingredient list, and ordered steps, and stores the structured data in memory.

### Step 8

The server uses the structured recipe data as input to a formatting module that prepares content for display on the terminal.

The server converts each recipe record into a presentation format, such as a hierarchical structure of titles, bullet lists for ingredients, and numbered lists for steps.

The server compiles all formatted recipes into an HTTP response payload and sets appropriate content-type and encoding headers.

The server outputs the HTTP response containing the formatted recipes and sends it to the terminal via the network interface.

### Step 9

The terminal receives the HTTP response from the server as input through its communication module.

The terminal parses the response payload to reconstruct the structured recipe data and associated display information.

The terminal maps the structured data to user interface components, such as recipe cards, ingredient lists, and step views, and renders them on the display device.

The terminal outputs a visual presentation of the generated recipes, enabling the user to browse titles, open detailed views, and read step-by-step instructions.

### Step 10

The user views the displayed recipes on the terminal as input to a decision-making process and selects a desired recipe by operating the input device, such as tapping a recipe card.

The terminal receives the user's selection and may request additional details or related recipes from the server if needed.

The server can use the selected recipe and the original prompt sentence as input to further processing, such as generating variations, adjusting serving sizes, or optimizing ingredient use.

The system outputs refined or additional structured recipe data back to the terminal, thereby iteratively improving the user's cooking experience based on structured interaction with the generative AI model and the prompt sentence.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional food recommendation and delivery systems primarily rely on simple keyword matching, static rule sets, or manually curated menus on a server. As a result, these systems cannot flexibly handle diverse, ambiguous, or context-rich natural language orders from users, such as mood-based requests, vague preferences, or requests constrained by ingredients currently available to the user. When such natural language orders are received, conventional systems often either fail to return a meaningful proposal or require extensive manual configuration and domain-specific engineering to produce an acceptable result.

At the same time, generic generative AI models running on a server are capable of producing recipes and dish descriptions from free-form prompts. However, when used in a naïve way, such models tend to ignore user-specific constraints, such as user preferences, dietary restrictions, ingredient possession information, and actual delivery availability. In typical architectures, the generative AI model is invoked as a standalone black box: the model receives a loosely defined prompt and returns unstructured text, while the surrounding server software must attempt ad hoc parsing and post-processing. This leads to inaccurate proposals, high parsing cost, and inconsistent behavior. Moreover, conventional systems do not tightly integrate the generative AI model with structured data sources such as recipe databases, user profiles, ingredient inventories, and delivery provider menus in a unified, closed loop. As a result, the server cannot efficiently transform a natural language order into an actionable, deliverable menu proposal that reflects the user's real-world constraints.

Further, in existing systems, the server usually treats intent detection, prompt construction, model invocation, and delivery arrangement as separate subsystems with loosely defined interfaces. This fragmented design causes redundant computations, delays, and brittle data flows: for example, intent classification may be performed by one component without reusing the result for prompt specialization, or delivery availability may be checked only after an unsuitable recipe has already been generated. This separation leads to increased latency, unnecessary load on computing resources, and difficulty in scaling the system to many concurrent users.

Accordingly, there is a need for an improved computer-implemented system and method in which a server processor systematically converts a user's natural language order into structured intent information, programmatically composes a rich, context-aware prompt sentence, and drives a generative AI model in coordination with local structured data stores. The technical challenge is to architect the server, memory, and communication interface so that the generative AI model is not used in isolation but instead operates as an integrated component in a data processing pipeline that (i) conditions generation on per-user history, preferences, and ingredient possession, (ii) produces structured output suitable for direct comparison with recipe and menu data in memory, and (iii) supports end-to-end automation from natural language order to delivery booking. Solving this challenge improves the functioning of the computer system itself by reducing redundant processing, increasing the relevance and structure of generated outputs, and enabling automated decision-making that was not feasible with conventional architectures.

The specific processing by the specific processing unit 290 of the data processing device 12 in Application Example 1 is realized by the following means.

The present invention provides a server comprising a processor, a memory, and a communication interface, the processor being configured to execute instructions that cause the server to receive, via the communication interface, order data including natural language order information and user identification information from a user terminal, to read, from the memory, user-specific history information, preference information, and ingredient possession information, to apply a natural language processing algorithm to the order information to perform tokenization and category classification and thereby specify intent information indicating whether the order corresponds to at least one of new recipe generation, existing recipe arrangement, ingredient substitution proposal, hidden flavor proposal, and mood- or preference-based dish proposal, to integrate the intent information, the history information, the preference information, and the ingredient possession information into a structured context, to generate, based on a template, a prompt sentence including at least a requested task, an output format, and constraint conditions as input to a generative AI model, to input the prompt sentence to the generative AI model and cause the generative AI model to execute probabilistic text generation processing to generate dish proposal data including at least one of a dish name, an ingredient list, amount information, cooking steps, ingredient substitution candidates, and hidden flavor candidates, to extract dish configuration information from the dish proposal data and compare the dish configuration information with recipe information and menu provision information of service providers stored in the memory in order to specify alternative ingredient candidates, menu candidates corresponding to or similar to the generated dish, and delivery availability information, and to transmit the dish proposal data and the menu candidates to the user terminal, receive order confirmation information from the user terminal, transmit delivery request data to an external delivery management system, receive delivery status information from the external delivery management system, and notify the user terminal of the delivery status information. This enables a tightly integrated, computer-implemented pipeline in which the server transforms unstructured natural language orders into structured, context-aware prompt sentences, drives a generative AI model to produce machine-processable dish proposals, and automatically reconciles those proposals with stored recipe and menu data and external delivery systems, thereby improving the efficiency, reliability, and technical capabilities of the underlying computing infrastructure.

The term “system” refers to a combination of hardware and software components including at least a processor, a memory, and a communication interface that cooperate to perform the claimed functions.

The term “processor” refers to one or more hardware computing units, such as a central processing unit or a graphics processing unit, configured to execute instructions to perform data processing operations described in the claims.

The term “memory” refers to one or more non-transitory computer-readable storage media, such as semiconductor memory or magnetic storage, configured to store data and executable instructions used by the processor.

The term “communication interface” refers to one or more hardware and software modules that enable data exchange between the system and external devices or networks, including wired or wireless communication modules.

The term “user terminal” refers to an information processing device operated by a user, such as a mobile device, a tablet device, or a general-purpose computing device, that transmits order data to and receives proposal data from the system.

The term “order data” refers to electronic data received from the user terminal that includes at least natural language order information and user identification information.

The term “natural language order information” refers to text or speech content expressed in a human language and input by a user to describe a desired dish, recipe, preference, or condition.

The term “user identification information” refers to data that allows association of received order data with a particular user, such as a user identifier, an account identifier, or equivalent information.

The term “history information” refers to stored data representing past interactions or records associated with a user, including past orders, accepted proposals, or feedback.

The term “preference information” refers to stored data representing user-specific likes, dislikes, dietary restrictions, or other stable or semi-stable taste attributes.

The term “ingredient possession information” refers to stored data indicating ingredients that are available to or owned by a user, including ingredients stored in a cold storage apparatus or other storage facility.

The term “natural language processing algorithm” refers to software logic executed by the processor that processes text or speech data in a natural language, including operations such as tokenization, segmentation, classification, or semantic analysis.

The term “tokenization” refers to a processing operation that divides a sequence of natural language characters or words into smaller units, such as tokens or symbols, for further analysis.

The term “category classification” refers to a processing operation that assigns one or more predefined categories or labels to input data, such as determining the type of user intent associated with natural language order information.

The term “intent information” refers to data representing the inferred purpose or type of a user's order, such as new recipe generation, existing recipe arrangement, ingredient substitution proposal, hidden flavor proposal, or mood- or preference-based dish proposal.

The term “attribute information” refers to data items that characterize a user, an order, or a context, including at least history information, preference information, ingredient possession information, and intent information.

The term “prompt sentence” refers to a structured textual input generated by the processor and supplied to a generative AI model, the input explicitly specifying a requested task, an output format, and one or more constraint conditions.

The term “template” refers to a predefined pattern or structure for generating a prompt sentence, including placeholders that are programmatically replaced with attribute information or context information.

The term “generative AI model” refers to a machine learning model configured to generate text or other data outputs based on input data, including, for example, a probabilistic language model, a sequence-to-sequence model, or a transformer-based model.

The term “probabilistic text generation processing” refers to a computation performed by the generative AI model in which subsequent tokens or words are predicted based on probability distributions conditioned on previously generated tokens and input information.

The term “dish proposal data” refers to data generated by the generative AI model in response to a prompt sentence, the data including at least one of a dish name, an ingredient list, amount information, cooking steps, ingredient substitution candidates, and hidden flavor candidates.

The term “dish configuration information” refers to structured information derived from dish proposal data, such as ingredient composition, cooking method, flavor profile, or other characteristics that describe a dish.

The term “recipe information” refers to data stored in the memory representing preparation instructions for dishes, including ingredients, quantities, cooking steps, and associated attributes.

The term “menu provision information” refers to data stored in the memory representing items offered by one or more service providers, including dish identifiers, availability, price information, and delivery conditions.

The term “alternative ingredient candidates” refers to ingredients proposed as substitutes for one or more ingredients specified in dish configuration information, while maintaining or approximating the desired flavor or properties of a dish.

The term “menu candidates” refers to one or more menu items identified from menu provision information as corresponding to or similar to a dish configuration generated by the generative AI model.

The term “delivery availability information” refers to data indicating whether a menu candidate can be delivered to a user, including information on serviceable areas, time windows, or operational status of a delivery service.

The term “order confirmation information” refers to data received from the user terminal indicating that a user has selected and confirmed a particular dish or menu candidate for ordering.

The term “delivery request data” refers to data transmitted from the system to an external delivery management system to initiate or modify delivery of one or more menu candidates, including identifiers, quantities, and delivery address information.

The term “delivery management system” refers to an external system operated by a service provider that manages preparation, dispatch, and delivery of menu items to users.

The term “delivery status information” refers to data received from the delivery management system indicating the current state of an order, including, for example, acceptance, preparation, dispatch, and completion status.

The term “existing recipe information” refers to recipe information stored in the memory prior to a particular user order, including established or pre-registered recipes.

The term “reference recipe data” refers to existing recipe information that has been selected as a base or baseline recipe corresponding to a dish name or attribute included in order data.

The term “arrangement recipe data” refers to data representing a modified version of reference recipe data, including at least one of flavor modification, nutritional value adjustment, or simplification of cooking steps.

The term “candidate recipe data” refers to recipe data that is considered as a potential basis for dish proposal, including either existing recipe information or arrangement recipe data.

The term “required ingredient information” refers to data specifying ingredients and quantities that are needed to prepare a dish according to candidate recipe data.

The term “missing ingredient information” refers to data identifying ingredients required by candidate recipe data that are not included in the ingredient possession information of a user.

The term “substitute ingredient candidates” refers to ingredients proposed in place of missing ingredient information while aiming to preserve desired culinary characteristics.

The term “hidden flavor candidates” refers to one or more ingredients suggested to be added in relatively small amounts to enhance or accentuate the flavor of a dish without substantially changing its primary characteristics.

In one embodiment, a server, a terminal, and a plurality of data stores cooperate to implement the claimed system. The server includes a processor, a memory, a communication interface, and optionally a hardware accelerator such as a graphics processing unit. The processor executes a program written, for example, in a high-level language such as Python running on an operating system such as a server-class operating system. The server hosts a web application framework such as a generic HTTP application framework and exposes an application programming interface (API) accessible from the terminal via a network such as the Internet.

The terminal is a user-operated information processing device such as a smartphone, a tablet device, or a general-purpose computer. The terminal executes an application implemented, for example, using a mobile application framework on a mobile operating system. The terminal includes a user interface configured to accept natural language text input from the user, to display proposed dishes and recipes, and to present order confirmation information. The terminal communicates with the server via a secure communication protocol such as HTTPS using a wireless or wired communication network.

The user operates the terminal to input natural language order information, such as “I want a spicy dish today,” “Make a lighter version of carbonara for lunch,” or “I want to make curry only with what I have.” The terminal converts the user input into digital character data, associates the character data with user identification information, and transmits the resulting order data to the server via the communication interface. The terminal may additionally retrieve local device information such as language settings or time zone information and include such information in the order data to allow the server to select appropriate processing parameters.

The server stores in the memory a set of structured data repositories such as a user profile repository, a recipe repository, a menu repository, a refrigerator inventory repository, and a log repository. In one concrete configuration, the server uses a relational database management system such as a general-purpose SQL database. The user profile repository stores, in a user table, entries including user identifiers, history information, preference information, and, optionally, allergy information and dietary restriction information. The recipe repository stores, in a recipe table, entries including dish identifiers, dish names, ingredient lists, ingredient amount information, cooking steps, and tags such as cuisine type or flavor profile. The menu repository stores, in a menu table, entries representing items offerable by service providers, including menu identifiers, dish identifiers, price information, availability information, and delivery conditions. The refrigerator inventory repository stores, in an ingredient possession table, entries indicating ingredient possession information for each user, including ingredient identifiers, quantities, and storage locations such as a cold storage apparatus. The log repository stores model input prompts and model outputs, associated with timestamps and user identifiers, for analysis and debugging.

The server implements a natural language processing module in software executed by the processor. The natural language processing module comprises a tokenizer, a text normalization component, and an intent classifier. The tokenizer segments input text into tokens according to language-specific rules and a vocabulary stored in the memory. The text normalization component performs lowercasing, punctuation normalization, and optional lemmatization to reduce variability in expressions. The intent classifier is implemented using a trained machine learning model, for example a neural network trained using a supervised learning method. The intent classifier takes as input a sequence of token identifiers and outputs a probability distribution over a set of intent classes such as new recipe generation, existing recipe arrangement, ingredient substitution proposal, hidden flavor proposal, and mood- or preference-based dish proposal.

In one embodiment, the intent classifier is implemented as a recurrent neural network, a convolutional neural network, or a transformer-based encoder network. The server stores the classifier parameters, including weight matrices and bias vectors, in the memory. During inference, the processor performs numerical operations such as matrix multiplications, vector additions, and non-linear activation functions (for example, rectified linear units or softmax functions). The classifier outputs a probability vector over intent classes; the processor selects the intent with the highest probability and stores the resulting intent information as part of the order analysis record. The server trains the intent classifier offline using a training dataset of labeled user queries. The server performs learning by minimizing a loss function such as cross-entropy via an optimization algorithm such as stochastic gradient descent or an adaptive gradient method. During training, the processor (or GPU) iteratively updates the weight parameters by computing gradients via backpropagation through time or through attention layers.

The server also stores and executes a generative AI model configured for probabilistic text generation. In one embodiment, the generative AI model is implemented as a transformer-based sequence-to-sequence neural network including an encoder module and a decoder module. The encoder module accepts as input a sequence of tokens representing a prompt sentence and computes contextualized vector representations using multi-head self-attention layers and feed-forward layers. The decoder module receives the encoder output and generates output tokens one by one, each time computing a probability distribution over the vocabulary conditioned on previously generated tokens and the encoder representations. The server represents each token as a numerical vector via an embedding matrix stored in memory. The generative AI model is trained in advance using a large corpus of recipe texts, dish descriptions, and cooking instructions. The server trains the model by minimizing a sequence prediction loss, such as negative log-likelihood, and updates model parameters via gradient-based optimization. The training may include data augmentation procedures such as synonym replacement, random masking, or paraphrase generation to improve robustness.

The server implements a prompt construction module configured to generate a structured prompt sentence for the generative AI model. The server maintains, in memory, one or more prompt templates, each template including fixed text segments and variable placeholders for attributes such as user request text, intent information, history information, preference information, and ingredient possession information. The processor fills these placeholders by retrieving the corresponding attribute information from the appropriate repositories. For example, when the user requests a spicy dish, the server retrieves stored preference information indicating that the user likes certain cuisines and dislikes certain ingredients, and retrieves refrigerator inventory information listing available ingredients. The processor then concatenates these data items into a single character string in accordance with a template. In one embodiment, the server constructs a prompt sentence of the following form:

“Use the generative AI model to propose an optimal dish and full recipe.

User request: ‘I want a spicy dish today.’

User profile: likes Japanese and Indian cuisine, dislikes coriander, no allergies.

User fridge items: chicken breast, onions, carrots, yogurt, garlic, curry powder, rice.

Return:
Dish name
Ingredients with amounts
Step-by-step cooking instructions
Short explanation of why this dish matches the user's request and uses the fridge items.”

In another embodiment directed to existing recipe arrangement, the server constructs a prompt sentence of the following form:

“Use the generative AI model to arrange the following existing recipe.

Base recipe: [carbonara ingredients and steps]

User request: ‘Make this carbonara lighter and suitable for lunch.’

Return a modified recipe that is lighter but still tasty, including dish name, ingredients with amounts, and clear cooking steps.”

In a further embodiment directed to ingredient substitution and hidden flavor suggestions, the server constructs a prompt sentence of the following form:

“Use the generative AI model to help the user cook with limited ingredients.

User request: ‘I want to make curry only with what I have.’

User fridge items: chicken breast, onions, carrots, yogurt, garlic, olive oil, salt, pepper, curry powder.

Base curry recipe requires: beef, onions, carrots, cream, garlic, oil, curry powder, salt.
1. Propose substitutions for missing ingredients using the fridge items.
2. Propose one ‘hidden flavor’that can be added in small amount to improve the taste.

Return a revised ingredients list, substitution mapping, and a short explanation for the hidden flavor.”

By employing structured prompt templates and explicit attribute insertion, the server constrains the generative AI model's operation to a well-defined task. This reduces the entropy of the model output, improves the alignment between generated text and user constraints, and reduces post-processing complexity. The use of structured prompts also increases computational efficiency, because the model is less likely to generate irrelevant or unusable content, thereby reducing wasted token generation and inference time.

The server parses the generated text output from the generative AI model into structured dish proposal data. The server uses deterministic parsing rules based on markers included in the prompt, such as section headings (“Dish name,” “Ingredients,” “Steps”), and regular expressions to separate ingredient lines and step lines. The server converts ingredient strings into normalized ingredient identifiers by matching against an ingredient dictionary stored in memory. The server associates quantities and units with numerical representations, enabling further computation such as nutritional estimation or cost estimation. This structured representation, called dish configuration information, is stored in the recipe repository, associated with the corresponding order and user.

The server then compares the dish configuration information with recipe information and menu provision information stored in memory. The server implements a matching module that computes a similarity score between the generated dish configuration and existing recipes or menu items. The similarity computation may use, for example, vector representations of dishes where each dish is represented as a sparse or dense vector over ingredient identifiers, cooking methods, and flavor tags. The server may compute cosine similarity or other distance measures between these vectors to identify menu candidates corresponding to or similar to the generated dish. Additionally, the server filters candidates using constraint checks based on user allergies, dislikes, and delivery availability information stored in the menu repository. By executing these algorithmic comparisons inside the server, the system avoids presenting impossible or inappropriate options to the user, thereby reducing network traffic and improving overall system reliability.

The server transmits to the terminal both the structured dish proposal data and a list of selected menu candidates. The terminal displays to the user the generated recipe, ingredients, steps, substitution suggestions, and hidden flavor proposals, as well as available menu items and delivery times. The user may select to cook the recipe themselves using the ingredient substitution and hidden flavor suggestions, or may select one of the menu candidates to be delivered. When the user confirms an order on the terminal, the terminal transmits order confirmation information back to the server. The server then constructs delivery request data including menu identifiers, user address information, and desired delivery time, and sends this data to an external delivery management system via a programmatic interface such as a web service interface.

In this way, the server is not merely automating a human decision process; rather, the server implements specific, non-conventional data structures and processing pipelines that improve the operation of the computer system itself. For example, by combining intent classification, structured prompt generation, and recipe/menu matching on the server side, the system reduces the number of generative model invocations and the volume of unstructured text that must be parsed. This reduces processor load and memory bandwidth usage on the server and decreases communication load between the server and the terminal. Additionally, by embedding user history and ingredient possession information directly into the prompt sentence, the generative AI model generates more relevant outputs in fewer tokens, improving computation efficiency and response latency.

The described architecture provides technical advantages compared to conventional systems that simply call a generative model with generic prompts. In conventional systems, a server often receives a free-form user query, submits it directly to a generative model, and then attempts to interpret the unstructured output. This requires repeated calls to the model and complex downstream parsing, increasing processing time and error rate. In contrast, the described server uses a multi-stage process: (i) natural language processing to derive intent information; (ii) retrieval of structured attributes from multiple databases; (iii) construction of a highly constrained prompt sentence; and (iv) structured parsing and database matching. This non-conventional combination of modules yields a reduction in parsing errors, an increase in the accuracy of matched menu candidates, and a reduction in computation time per request, as the generative model can be run with narrower task scopes and shorter generation lengths.

In another embodiment, the server uses a variant generative AI model architecture such as a decoder-only transformer network with multiple attention heads and positional encoding. The server may use quantization or pruning techniques to compress the model parameters and store them more efficiently in memory, thereby decreasing memory footprint and increasing throughput. The server may also use batching strategies to process multiple user prompts concurrently, amortizing the cost of model execution across users and increasing the number of handled requests per second.

The server can further adapt the generative AI model to individual users by performing fine-tuning using feedback data. When the user provides feedback or ratings via the terminal, the server stores such feedback linked to specific dish proposals and menu selections. The server then uses this feedback to adjust training data or to update model parameters via additional gradient descent steps. The learning process may use a loss function incorporating both prediction error and user satisfaction measures. This adaptive training process yields customized behavior for different user populations, further improving the technical performance of the system in terms of recommendation precision.

The system may also include alternative embodiments for specific modules. For example, the natural language processing module may be replaced with a different classifier architecture, such as a support vector machine or a gradient-boosted decision tree model, provided that the classifier outputs intent information. The generative AI model may be implemented using different neural network frameworks or libraries, or may be deployed on specialized hardware accelerators. The data repositories may be implemented using non-relational databases or in-memory key-value stores to increase retrieval speed.

In all of these embodiments, the server integrates heterogeneous forms of data—unstructured natural language, user profiles, refrigerator inventories, and structured menu data—into a unified processing pipeline driven by explicit prompt sentences and a generative AI model. This integration enables the server to perform operations that are not readily achievable by human operators, such as near-real-time generation of personalized recipes constrained by current inventory and delivery availability, coupled with structured matching to external service providers. As a result, the system realizes technical effects including reduced end-to-end latency, improved accuracy of recipe and menu recommendations, improved utilization of storage and computation resources on the server, and decreased network bandwidth consumption between the server and the terminal.

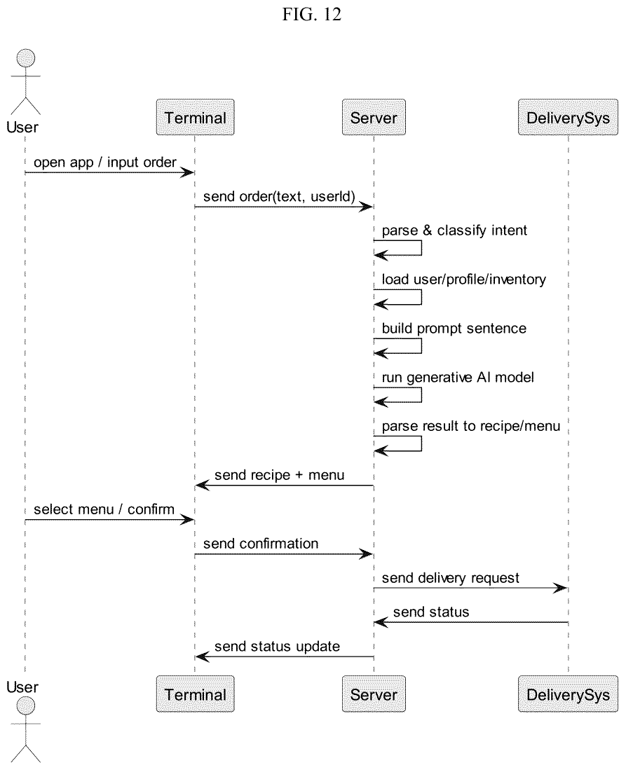

The following describes the processing flow using FIG. 12.

### Step 1

User operates the terminal to launch an application and input a natural language order.

User types, for example, “I want a spicy dish today” or “Make a lighter version of carbonara for lunch” into a text field.

Terminal receives the text as input, associates it with user identification information stored locally (for example, a user ID token), and constructs order data including natural language order information, user identification information, and optional device settings such as language and time zone.

Terminal performs data formatting by encoding the character string into a predetermined character encoding and packing the fields into a structured message, then outputs the order data and transmits it via a network protocol such as HTTPS to the server.

### Step 2

Server receives the order data from the terminal through a communication interface.

Server takes as input the structured message containing the natural language order information and user identification information, and parses the message headers and body to extract these fields.

Server performs validation by checking that mandatory fields are present and that the user identification information corresponds to a registered user, then outputs a normalized order record containing the order text, user ID, and reception timestamp.

Server writes this normalized order record into a database table, thereby storing the raw request for subsequent processing.

### Step 3

Server retrieves user-related context data from memory.

Server takes as input the user ID from the normalized order record and executes database queries to read history information, preference information, and ingredient possession information from user profile and refrigerator inventory tables.

Server performs data aggregation by merging multiple query results into a single context structure, for example a composite object that includes prior accepted dishes, disliked ingredients, allergy information, and a list of currently possessed ingredients.

Server outputs the aggregated context data, linked to the order record, for use in later natural language processing and prompt construction.

### Step 4

Server analyzes the natural language order to determine intent.

Server takes as input the order text from the normalized order record and feeds it into a natural language processing module.

Server first performs tokenization and normalization, converting the text into a sequence of token identifiers, then applies an intent classification model to compute a probability distribution over predefined intent categories such as new recipe generation, existing recipe arrangement, ingredient substitution proposal, hidden flavor proposal, and mood- or preference-based dish proposal.

Server performs data computation by executing matrix multiplications and non-linear activations in the classifier network, then selects the intent with the highest probability and outputs intent information indicating the detected category, storing it in association with the order record.

### Step 5

Server selects or prepares base recipe data if required.

Server takes as input the intent information and the order text, and determines whether the request refers to a specific known dish or requires use of existing recipe information.

Server executes database search operations in the recipe repository using the dish name or tags parsed from the order text, and retrieves base recipe data including dish name, ingredient list, and cooking steps when an existing recipe arrangement or substitution scenario is detected.

Server outputs either a reference recipe data structure or a flag indicating that no base recipe is needed, and associates this output with the order record for use in prompt construction.

### Step 6

Server constructs a prompt sentence for the generative AI model.

Server takes as input the intent information, the aggregated context data, and any reference recipe data, and selects an appropriate prompt template from memory.

Server performs string processing by inserting the user request text, user preferences, ingredient possession information, and optionally base recipe content into placeholder positions within the template, thus generating a complete prompt sentence.

Server outputs a finalized prompt sentence as a single text string; for example:

“Use the generative AI model to propose an optimal dish and full recipe.

User request: ‘I want a spicy dish today.’

User profile: likes Japanese and Indian cuisine, dislikes coriander, no allergies.

User fridge items: chicken breast, onions, carrots, yogurt, garlic, curry powder, rice.

Return:
Dish name
Ingredients with amounts
Step-by-step cooking instructions
Short explanation of why this dish matches the user's request and uses the fridge items.”

### Step 7

Server executes the generative AI model using the prompt sentence.

Server takes as input the prompt sentence and encodes it into token identifiers through a tokenizer associated with the generative AI model.

Server performs numerical computation by feeding the token sequence into a neural network architecture such as a transformer, where the processor or accelerator executes matrix multiplications, attention calculations, and activation functions to iteratively compute probability distributions over output tokens.

Server samples or selects tokens according to configured generation parameters (for example, maximum length, temperature, and top-k or top-p values), concatenates the generated tokens into an output text, and outputs dish proposal data in text form including, for example, a dish name, ingredients with amounts, cooking steps, and substitution or hidden flavor suggestions.

### Step 8

Server parses the dish proposal data into structured form.

Server takes as input the generated output text and applies rule-based parsing logic using known section markers such as “Dish name,” “Ingredients,” and “Steps.”

Server performs data extraction by splitting the text at delimiters, converting ingredient lines into ingredient entries with names, quantities, and units, and converting step lines into ordered instructions.

Server normalizes ingredient names by matching them against an ingredient dictionary, assigns internal identifiers, and outputs a structured dish configuration data structure containing at least a normalized ingredient list, amount information, and ordered cooking steps.

### Step 9

Server matches the structured dish configuration with stored recipes and available menu items.

Server takes as input the dish configuration data and queries the recipe repository and menu repository to retrieve candidate records for comparison.

Server performs similarity computations by constructing feature vectors for the generated dish and for candidate entries, where features may include ingredient presence, cooking methods, and flavor tags; the server then computes similarity scores, for example using cosine similarity or other distance measures.

Server filters candidate menu items using user constraints such as allergies and dislikes, and using delivery availability information, and outputs a list of menu candidates corresponding to or similar to the generated dish, along with any identified alternative ingredient candidates derived from the comparison.

### Step 10

Server transmits the dish proposal data and menu candidates to the terminal.

Server takes as input the structured dish configuration data and the list of menu candidates, and packages them into a response message containing recipe details, substitution and hidden flavor suggestions, and delivery options.

Server performs serialization of these data into a structured response format and sends the response over the network to the terminal via the communication interface.

Terminal receives the response as input, deserializes the structured data into local objects representing the recipe and menu items, and outputs the data by rendering user interface components such as lists, detail views, and selection buttons on the display.

### Step 11

User reviews the proposals and issues an order confirmation.

User observes, on the terminal display, the generated recipe, including dish name, ingredients, and steps, and the proposed menu candidates with associated delivery information.

User selects a desired menu candidate and confirms the order via a user interface control such as an “Order” button.

Terminal takes the user's selection and confirmation as input, constructs order confirmation information including selected menu identifier, quantity, and delivery address, and outputs this confirmation message by transmitting it to the server over the network.

### Step 12

Server arranges delivery based on the order confirmation.

Server takes as input the order confirmation information and validates that the selected menu item remains available and deliverable.

Server constructs delivery request data including user address, menu identifier, quantity, and desired delivery window, and performs data transmission to an external delivery management system using a programmatic interface.

Server receives from the external system delivery status information such as acceptance and estimated delivery time, and outputs this status by updating order records in the database and sending status notifications to the terminal.

### Step 13

Terminal presents delivery status and final information to the user.

Terminal takes as input the status notifications from the server, including delivery state transitions such as “accepted,” “preparing,” and “out for delivery.”

Terminal performs user interface updates by refreshing status indicators, estimated times, and tracking information on the display, and may generate local notifications or alerts.

User views the updated status output on the terminal and uses this information to anticipate delivery and optionally provide post-delivery feedback through additional inputs.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented recipe suggestion systems typically rely on fixed rule sets, manually curated templates, or simple keyword matching to generate cooking instructions. Such systems generally are not capable of deeply interpreting free-form natural language requests from users, handling ambiguous or underspecified requests, or flexibly adapting recipes to available ingredients and dietary constraints. As a result, existing systems frequently produce outputs that are either irrelevant, overly generic, or require substantial manual refinement by the user. From a computer technology standpoint, the pipeline that converts unstructured natural language input into a structured, machine-usable specification for recipe generation is underutilized and inefficient: the systems do not systematically identify and separate key semantic components (such as dish type, dietary style, flavor preference, ingredient shortages, and substitution needs), nor do they generate optimized input instructions for downstream generative models.

Furthermore, when a generative AI model is integrated, conventional approaches often pass the user's raw text directly to the model without constructing a precise, context-rich prompt sentence. This causes unstable generation quality, inconsistent output formats, and an increased need for post-processing. The computing resources consumed by the generative AI model are therefore not efficiently used, because the model must internally infer structure that the system could have pre-computed. Additionally, current systems do not systematically incorporate explicit substitution logic for missing ingredients or explicit handling of vague, flavor-oriented requests into the prompt design. This leads to repeated round-trip interactions, increases latency, and degrades the overall responsiveness and reliability of the computer system in generating actionable, structured recipe data.

In view of these issues, there is a need for an improved computer-implemented technique that: (i) programmatically analyzes natural language cooking-related requests and available ingredient data to extract semantically distinct elements, including dish type, dietary restriction, flavor preference, ambiguity level, and ingredient shortages; (ii) constructs a structured, context-aware prompt sentence that explicitly instructs a generative AI model what to generate and in what format; (iii) incorporates explicit directives for generating modification recipes, substitution candidates, and flavor change explanations; and (iv) converts the generative AI output into structured data suitable for reliable presentation and downstream computational use. By improving the way the processor configures and orchestrates analysis, prompt generation, and structured post-processing, the invention aims to enhance the technical performance of the overall recipe generation system, including stability of outputs, efficiency of model usage, reduction of unnecessary interactions, and improved suitability of the data for machine processing.

The specific processing by the specific processing unit 290 of the data processing device 12 in Example 2 is realized by the following means.

The present invention provides a server comprising a processor configured to receive, from a user terminal, cooking-related preference conditions and information on available ingredients, analyze the received preference conditions and ingredient information by using natural language processing to identify at least a type of dish, a dietary restriction, a flavor preference, a shortage ingredient, and a degree of ambiguity of a user request, generate a prompt sentence, based on the identified type of dish, dietary restriction, flavor preference, shortage ingredient, necessity of proposing a substitution for the shortage ingredient, necessity of presenting multiple options for an ambiguous request, and an output-format condition, the prompt sentence being configured to instruct a generative AI model to generate at least a cooking procedure, a modification of an existing dish, a substitution proposal for an ingredient, and a flavor proposal, input the generated prompt sentence to the generative AI model, obtain, from the generative AI model, cooking procedure information, modification recipe information, ingredient substitution information, and flavor proposal information, and convert the obtained cooking procedure information, modification recipe information, ingredient substitution information, and flavor proposal information into structured data including at least a cooking step, an ingredient list, a substitution candidate, and a flavor description, and format the structured data into a presentation format for the user terminal. This enables the computing system to more efficiently transform unstructured user input into an optimized prompt for the generative AI model, to obtain stable and machine-structurable output from the model, to incorporate explicit handling of ingredient shortages and ambiguous requests at the prompt-design level, and thereby to improve the technical performance of the overall recipe generation pipeline, including reduction of processing overhead, enhancement of response consistency, and increased suitability of the generated data for automated presentation and further computational processing.

The term “system” refers to an arrangement of one or more hardware components and software components that cooperate to perform processing, including at least a processor configured to execute instructions.

The term “processor” refers to one or more hardware processing units, such as a central processing unit or a graphics processing unit, configured to execute computer-readable instructions to perform data processing operations.

The term “user terminal” refers to an information processing device, such as a mobile device, a tablet device, a personal computer, or a similar computing apparatus, operated by a user to input data to and receive data from the system.

The term “cooking-related preference conditions” refers to information indicating a user's desired attributes for a dish, including at least a type of dish, a dietary restriction, a flavor preference, and other constraints on preparation or ingredients.

The term “available ingredients” refers to materials usable for preparing a dish, including food items stored in a storage apparatus or otherwise indicated by the user as being on hand.

The term “natural language processing” refers to a technique or a set of techniques for analyzing and interpreting text expressed in a human language, including operations such as tokenization, part-of-speech tagging, entity extraction, intent recognition, and classification.

The term “type of dish” refers to a category or classification of a dish, such as a main dish, a side dish, a soup, a dessert, or another dish category inferred from user input.

The term “dietary restriction” refers to a limitation or rule related to food intake, such as vegetarian, vegan, low-salt, low-sugar, allergen-free, or other nutritional or medical constraints.

The term “flavor preference” refers to a user's desired taste or aroma characteristic for a dish, such as spicy, mild, rich, light, refreshing, or similar flavor-related attributes.

The term “shortage ingredient” refers to an ingredient that is required or typical for a particular dish but is not present in the available ingredients.

The term “degree of ambiguity of a user request” refers to a measure or classification indicating how specific or vague the user's cooking-related request is, including whether a particular dish, cuisine, or ingredient set has been clearly specified.

The term “prompt sentence” refers to a text instruction or query generated by the processor, formatted as natural language, and configured to be input to a generative AI model to cause the generative AI model to output specified types of information.

The term “generative AI model” refers to a machine learning model configured to generate text or other data based on an input prompt sentence, including but not limited to probabilistic language models, transformer-based models, or similar generative models.

The term “cooking procedure” refers to a sequence of operations or steps for preparing a dish from ingredients, including actions, ordering, and conditions such as time and temperature.

The term “modification of an existing dish” refers to a variation of a known dish that changes at least one of ingredients, quantities, or cooking steps to create a different or adapted recipe.

The term “substitution proposal for an ingredient” refers to a suggestion of one or more alternative ingredients that may replace a shortage ingredient or undesired ingredient while maintaining or adjusting the desired characteristics of the dish.

The term “flavor proposal” refers to information describing how to adjust or enhance the taste or aroma of a dish, including proposals to add, remove, or change seasonings, herbs, spices, or other flavor-related elements.

The term “cooking procedure information” refers to data output from the generative AI model that describes a cooking procedure, including at least one ordered list of cooking steps.

The term “modification recipe information” refers to data output from the generative AI model that describes a recipe representing a modification of an existing dish, including changed ingredients and changed cooking steps.

The term “ingredient substitution information” refers to data output from the generative AI model that describes substitution ingredient candidates, conditions for substitution, and effects of substitution on the dish.

The term “flavor proposal information” refers to data output from the generative AI model that describes flavor characteristics of a dish and recommended adjustments to achieve a desired flavor profile.

The term “structured data” refers to data organized according to a predefined schema or format, such as a data structure including fields for a cooking step, an ingredient list, a substitution candidate, and a flavor description.

The term “cooking step” refers to an individual operation or instruction within a cooking procedure, such as chopping, mixing, heating, or serving, associated with an ordering in time.

The term “ingredient list” refers to a collection of ingredients used for a dish, each ingredient optionally associated with a quantity, a unit, and preparation notes.

The term “substitution candidate” refers to an ingredient proposed as a replacement for another ingredient, including conditions or notes for such replacement.

The term “flavor description” refers to text describing the expected taste, aroma, mouthfeel, or overall flavor profile of a dish.

The term “presentation format” refers to a layout or data structure suitable for display or output on a user terminal, including arrangements of titles, lists, and steps.

The term “existing dish” refers to a dish that is known or pre-defined, including a dish for which standard ingredient configurations and standard cooking procedures are stored in a storage device.

The term “change condition” refers to a user-specified requirement indicating how an existing dish should be altered, including changes to ingredients, flavor, preparation time, or nutritional characteristics.

The term “storage device” refers to a hardware component or subsystem configured to store data, such as a memory device, a hard disk device, or a solid-state storage device.

The term “standard ingredient configuration” refers to a data set representing typical or default ingredients and their relationships for an existing dish.

The term “standard cooking procedure” refers to a data set representing typical or default cooking steps for an existing dish.

The term “difference between the change condition and the standard ingredient configuration and the standard cooking procedure” refers to a computed variation that indicates how user-specified changes deviate from default ingredients and default cooking steps for an existing dish.

The term “storage apparatus” refers to a physical apparatus for maintaining ingredients, such as a refrigerated storage apparatus or another food-storage apparatus, combined with a data acquisition mechanism for ingredient information.

The term “recipe database” refers to a logical or physical collection of recipe-related records stored in a storage device, including at least standard ingredient configurations and standard cooking procedures.

The term “substitution ingredient candidate” refers to an ingredient that is proposed, based on computation or model output, as a possible replacement for a shortage ingredient.

The term “flavor change” refers to a difference in taste, aroma, or related sensory characteristic of a dish that occurs when a substitution ingredient candidate is used in place of another ingredient.

In one embodiment, a server, a terminal, and a user cooperate to implement the invention. The server includes at least one hardware processor, a memory, a nonvolatile storage device, and a network interface. The terminal includes a display unit, an input unit, a communication unit, and a local processor. The user operates the terminal to input cooking-related information and to view proposed recipes.

The server executes a computer program stored in the memory. The program is implemented, for example, on a general-purpose computing platform executing an operating system, and uses middleware such as a web server framework and an application framework. The server communicates with the terminal via a communication network such as the Internet using a transport protocol.

The terminal runs an application program that provides a user interface for entering cooking-related preference conditions and available ingredient information. The user uses a pointing device or a touch panel of the terminal to input free-form text, select items from lists, and confirm operations. The terminal converts the user's operations into structured request data including at least a text field for a request description and a list field for available ingredients, and the terminal transmits the request data to the server via the communication unit.

The server stores the received request data in the memory using a predefined data structure. In one embodiment, the server represents the request data as a record including fields such as a user identifier, a timestamp, a natural language request string, a normalized ingredient vector, and a constraint vector. The normalized ingredient vector is generated by mapping ingredient names to canonical identifiers using an ingredient dictionary stored in a storage device. The constraint vector may include flags indicating dietary restrictions and cooking constraints.

The server applies a natural language processing pipeline to the natural language request string. The server uses a tokenizer module to segment the text into tokens and uses a syntactic and semantic analysis module to derive parts of speech and named entities. The server then uses an intent classification model to assign the request to one or more categories such as “new recipe generation,” “existing dish modification,” “substitution-focused,” or “flavor-focused.” In one embodiment, the server uses a supervised classification algorithm implemented as a multilayer neural network trained on labeled cooking-related text, where the network receives as input an embedded representation of the token sequence and outputs a probability distribution over intent labels.

The server further uses extraction logic to identify a type of dish, dietary restrictions, and flavor preferences. In one example, the server maintains a lookup table mapping keywords (such as “pasta,” “soup,” “dessert,” “vegetarian,” “spicy,” “light,” and similar terms) to high-level categories. The server maps each detected term to a category identifier and stores the identifiers in the constraint vector. The server also evaluates a degree of ambiguity of the user request by computing a metric based on the number of concrete entities and action verbs in the request and on the classification confidence. When the degree of ambiguity exceeds a threshold, the server sets a flag indicating that multiple candidate menus or flavor profiles should be proposed.

The server identifies shortage ingredients by comparing the normalized ingredient vector with a standard ingredient configuration associated with candidate dishes. In one embodiment, the server stores in a recipe database a plurality of standard recipes, each recipe including a list of canonical ingredient identifiers and a list of cooking steps. The server uses similarity computation between the user request representation and the recipe metadata to retrieve one or more candidate standard recipes. The server then computes a set difference between the ingredient list of each candidate standard recipe and the normalized ingredient vector of the request. The elements of the set difference are registered as shortage ingredients. The server also references a substitution knowledge base, which maps canonical ingredient identifiers to sets of potential substitution ingredient identifiers and to associated flavor-change descriptors, and the server records this mapping in an internal substitution structure. The server constructs a prompt sentence for a generative AI model. The server uses a template-based generator that combines fixed text segments with variable segments derived from the analyzed data. The server selects a template according to the intent classification result and the ambiguity flag. For example, when the user has requested a new vegetarian pasta recipe and the server has detected shortage ingredients, the server generates a prompt sentence such as:

“The user wants a new vegetarian pasta dish using zucchini, garlic, and olive oil. The user does not have tomatoes or Parmesan cheese. Propose a creative vegetarian pasta recipe. Provide: (1) a recipe title, (2) an ingredients list with quantities, (3) step-by-step cooking instructions, (4) at least two alternative ingredients for tomatoes and Parmesan cheese, and (5) a brief explanation of the flavor profile.”

When the user has provided only a vague, flavor-oriented request, the server generates a different prompt sentence such as:

“The user wants a light and refreshing dinner but did not specify a particular dish or cuisine. Propose three different dinner ideas with a light and refreshing flavor profile. For each idea, provide: (1) the dish name, (2) key ingredients, (3) short step-by-step instructions, and (4) a brief explanation of why the flavor feels light and refreshing.”

When the user has requested a creamy pasta but lacks a typical ingredient, the server generates a prompt sentence such as:

“The user wants a creamy pasta but does not have cream. The user has milk and yogurt. Propose a creamy pasta recipe that uses milk and/or yogurt instead of cream. Provide: (1) a recipe title, (2) ingredients and quantities, (3) step-by-step instructions, (4) a clear explanation of how to substitute cream with milk or yogurt, and (5) a description of the resulting flavor and texture.”

The server thus programmatically encodes semantic analysis results into the prompt sentence. The server represents the prompt sentence internally as a sequence of characters and as a corresponding sequence of token identifiers produced by a tokenizer compatible with the generative AI model.

The server uses a generative AI model implemented as a trained neural network, such as a transformer-based language model. In one embodiment, the server uses a model comprising multiple self-attention layers, feed-forward layers, and layer normalization units. The server stores model parameters in a model storage unit. Each self-attention layer includes weight matrices used to compute query, key, and value vectors from the token embeddings, and the server performs matrix multiplications to compute attention scores and context vectors. The server applies non-linear activation functions such as rectified linear units or similar functions in the feed-forward layers. The server executes these operations on a hardware accelerator such as a graphics processing unit to improve processing throughput.

The server trains the generative AI model in advance using a corpus of textual recipe data, ingredient substitution data, and flavor description data. The server uses a training module that performs stochastic gradient descent or a variant such as Adam optimization. The server defines a loss function that includes at least a next-token prediction error term, and may include additional regularization terms to emphasize structural consistency of recipes, such as penalties for missing ingredients in steps or inconsistent quantities. The server updates the weights of the model based on the gradient of the loss function computed by back-propagation. The server optionally uses data augmentation techniques, for example by paraphrasing recipe descriptions or randomly masking ingredients, to increase robustness. The server stores the resulting trained model as the generative AI model used at inference time.

During inference, the server inputs the tokenized prompt sentence into the generative AI model and obtains a sequence of output token probabilities at each position. The server selects tokens based on a decoding algorithm such as greedy decoding, beam search, or top-k sampling, under configuration parameters set in the application logic. The server accumulates the selected tokens until an end-of-sequence condition is satisfied, and the server decodes the token identifiers back into a text sequence that contains at least a recipe title, an ingredient list, cooking steps, substitution proposals, and flavor descriptions as directed by the prompt sentence.

The server converts the generated text into structured data. The server uses parsing rules that rely on the explicit output format instructions embedded in the prompt sentence. For example, the server detects numbered lists to identify cooking steps, detects section labels to separate ingredients and substitutions, and uses pattern recognition to extract quantities and units. The server then stores the structured data in a hierarchical data structure comprising fields such as “title,” “ingredients,” “steps,” “substitutions,” and “flavor_notes.” Each ingredient entry may contain subfields for a canonical ingredient identifier, a displayed name, a quantity, a unit, and a preparation note. Each substitution entry may include a target ingredient identifier, one or more substitution ingredient identifiers, and a flavor-change descriptor. The server stores this structured data in the memory or in a database.

The server transmits the structured data to the terminal in a format configured for rendering by the terminal application. The terminal receives the structured data and uses its local processor to map the structured fields to user interface components. The terminal displays the recipe title and lists the ingredients with interactive elements. The terminal displays step-by-step instructions, allowing the user to scroll or navigate between steps. The terminal displays substitution and flavor information in a dedicated area. The user can choose to request modifications by providing additional input; when the user does so, the terminal packages the new constraints with an identifier of the previously generated structured data and sends this information back to the server.

In another embodiment, the server uses multiple smaller modules rather than a single generative AI model. For instance, the server may use one generative AI model specialized for base recipe generation and another generative AI model or rule-based module specialized for substitution explanation. The server may also vary the decoding parameters to trade off between diversity and determinism depending on the detected ambiguity level of the user request. When the user's request is highly specific, the server chooses a decoding configuration that reduces randomness to improve reproducibility and minimize post-processing. When the request is vague and exploratory, the server chooses a decoding configuration that allows greater diversity, thereby providing a wider range of options.

The server improves computer technology by separating and precomputing semantic components of the user request and by encoding them into the prompt sentence. Because the server performs natural language analysis, ingredient normalization, shortage detection, and constraint encoding before sending requests to the generative AI model, the model receives a more structured and constrained prompt. This reduces the internal inference burden on the model, which results in fewer unnecessary tokens generated and in a lower rate of structurally invalid outputs. Consequently, the server reduces overall computation time on the neural network hardware, lowers memory bandwidth usage during inference, and decreases the number of client-server round trips needed to obtain a satisfactory recipe. The server further reduces communication load by returning structured data that can be directly rendered by the terminal without extra clarification requests.

The server also improves accuracy and consistency of recipe outputs. The pre-analysis of ingredients and constraints helps prevent contradictions, such as suggesting non-vegetarian ingredients in a vegetarian recipe, by encoding explicit constraints into the prompt sentence. The shortage ingredient detection and substitution knowledge base cause the generative AI model to receive explicit instructions about which ingredients cannot be used and which substitution candidates are preferred. As a result, the server reduces the frequency of outputs that require manual human correction, which is a technical improvement in the quality of machine-generated data.

The server uses non-conventional processing rules that differ from manual recipe creation. A human user typically reasons holistically about dish ideas, while the server applies deterministic or learned procedures for vectorizing ingredients, matching against standard configurations, and computing set differences to identify shortages. The server also applies an explicit ambiguity metric to decide when to request multiple menu proposals, which is a machine-oriented control flow determined by measurable features of the text. These operations are performed according to specific algorithms operating on well-defined data structures, which distinguishes them from mere automation of human judgment.

In yet another embodiment, the server logs structured interaction histories for each user in a storage device. The server analyzes these histories to infer long-term preferences and uses these preferences as context in the prompt generation. The server may summarize historical data into compact representations (such as preference vectors) using dimensionality reduction techniques or additional neural encoders. The server then inserts short descriptions of inferred preferences into the prompt sentence. This reduces the need to transmit full histories for each request, thereby lowering communication overhead between the server and the terminal and reducing the data volume processed by the generative AI model.

The system can be deployed in various configurations. In one configuration, the generative AI model runs on the same physical server as the application logic; in another configuration, the generative AI model runs on a separate inference server connected over a data center network. The server may dynamically select which model instance to use based on current load, model size, or latency requirements. The terminal can be any device capable of running the client application, including mobile devices, tablets, or stationary displays integrated in a cooking environment.

Through these embodiments, the server, the terminal, and the user cooperate to execute a sequence of technical operations that transform unstructured natural language input and raw ingredient information into structured, machine-usable recipe data via a generative AI model guided by carefully constructed prompt sentences. This arrangement provides improvements in processing speed, output accuracy, consistency of data structure, and communication efficiency, and therefore constitutes an improvement in computer technology rather than a mere automation of human cognitive tasks.

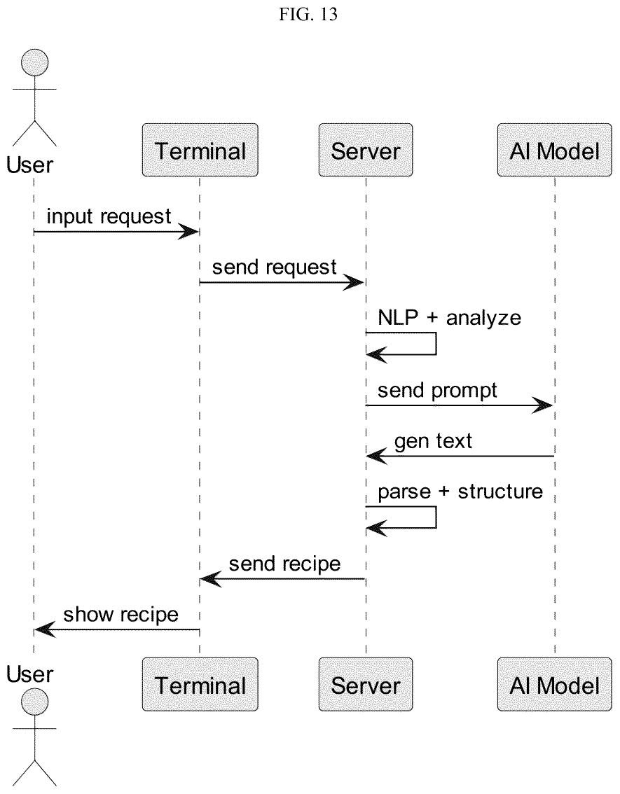

The following describes the processing flow using FIG. 13.

### Step 1

User operates the terminal to launch a cooking-support application and to input a cooking-related request. User enters, as input, free-form text describing a desired dish or flavor (for example, “I want a new vegetarian pasta dish. I have zucchini, garlic, and olive oil. I don't have tomatoes.”) and selects available ingredients from a list displayed on the terminal. Terminal receives these inputs and converts them into initial request data, which includes at least a natural language request string and a raw list of user-selected ingredients. Terminal outputs this initial request data to the communication unit.

### Step 2

Terminal structures the initial request data into a machine-usable format. As input, terminal uses the natural language request string and the raw ingredient list from Step 1. Terminal performs data processing, such as mapping user interface selections to internal identifiers, normalizing character encoding, and constructing a structured record containing fields such as “request_text,” “available_ingredients,” and “user_constraints.” Terminal outputs a structured request message, for example a record or object, and transmits this structured request message to the server via a network connection.

### Step 3

Server receives the structured request message from the terminal through the network interface. As input, server takes the structured request message that includes the natural language request string and the available ingredient list. Server validates the message by checking for required fields, verifying data types, and rejecting malformed input. Server then stores a validated copy of the message in memory as a request record. Server outputs a normalized request record that is ready for subsequent natural language analysis.

### Step 4

Server performs natural language preprocessing on the request_text field. As input, server uses the request_text string from the normalized request record. Server applies a tokenizer to segment the text into tokens, and uses a part-of-speech tagger and named entity recognizer to label token-level information. Server executes these computations using a natural language processing library, which runs on the processor and may utilize vector operations. Server outputs a tokenized and annotated representation of the request_text, which includes token indices and associated linguistic tags.

### Step 5

Server performs intent classification and category extraction based on the tokenized representation. As input, server uses the tokens and their embeddings produced in Step 4. Server feeds these embeddings into a trained classification neural network that computes, via matrix multiplications and non-linear activations, a probability distribution over intent classes such as “new_recipe,” “modify_existing,” “substitution_request,” and “flavor_focus.” Server selects the highest-probability class as the intent label and also extracts dish type, dietary restriction, and flavor preference by matching detected keywords against predefined category tables. Server outputs an intent label and a constraint vector that encodes dish type, dietary restrictions, and flavor preferences as categorical or binary values.

### Step 6

Server normalizes the available ingredient list and computes an ingredient vector. As input, server uses the available_ingredients field from the request record. Server matches each ingredient name to a canonical ingredient identifier using a dictionary stored in a database and converts the list into a canonical ingredient vector, for example a list of integer identifiers or a sparse binary vector. Server also removes duplicates and resolves synonyms. Server outputs a normalized ingredient vector and an ingredient identifier list associated with the request.

### Step 7

Server retrieves candidate standard recipes from a recipe database and detects shortage ingredients. As input, server uses the intent label, constraint vector, and normalized ingredient vector from Steps 5 and 6. Server queries the recipe database for standard recipes matching the dish type and dietary restrictions and receives candidate recipes, each containing a standard ingredient configuration. Server computes a set difference between each candidate recipe's ingredient set and the normalized ingredient vector by comparing canonical ingredient identifiers using set algebra. Server identifies ingredients present in the standard recipe but absent from the user's available ingredients as shortage ingredients. Server outputs a list of shortage ingredient identifiers and, optionally, a selected reference recipe identifier.

### Step 8

Server evaluates ambiguity of the user request and determines whether multiple options should be proposed. As input, server uses the tokenized request from Step 4 and the intent label and constraint vector from Step 5. Server computes an ambiguity score based on features such as the number of concrete ingredient mentions, the presence or absence of explicit dish names, and the confidence value of the intent classifier. Server compares the ambiguity score to a predefined threshold. If the score exceeds the threshold, server sets a multiple_options flag. Server outputs an ambiguity flag and the multiple_options flag to be used in prompt construction.

### Step 9

Server prepares semantic elements for prompt sentence generation. As input, server uses the constraint vector, normalized ingredient vector, shortage ingredient list, ambiguity flag, and multiple_options flag from previous steps. Server transforms these elements into textual fragments, such as a list of available ingredients described in natural language, a textual formulation of shortage ingredients, and sentences describing dietary restrictions and flavor preferences. Server concatenates these fragments into intermediate prompt components, ensuring that each component corresponds to a specific semantic aspect (for example, “available ingredients,” “missing ingredients,” “constraints,” “output format”). Server outputs a set of intermediate textual components for the prompt.

### Step 10

Server generates a complete prompt sentence for a generative AI model. As input, server uses the intermediate textual components from Step 9 and the intent label from Step 5. Server selects a prompt template matching the intent (for example, a template for new recipes, for modifications, or for substitution-focused queries). Server then fills template placeholders with the textual components, appends explicit instructions about the required output sections (title, ingredients, steps, substitutions, flavor explanation), and, when the multiple_options flag is set, adds instructions to propose multiple recipe ideas. Server performs string concatenation and formatting operations to produce a single coherent natural-language prompt sentence. Server outputs the final prompt sentence, such as: “The user wants a new vegetarian pasta dish using zucchini, garlic, and olive oil. The user does not have tomatoes or Parmesan cheese. Propose a creative vegetarian pasta recipe. Provide: (1) a recipe title, (2) an ingredients list with quantities, (3) step-by-step cooking instructions, (4) at least two alternative ingredients for tomatoes and Parmesan cheese, and (5) a brief explanation of the flavor profile.”

### Step 11

Server tokenizes the prompt sentence and prepares input data for the generative AI model. As input, server uses the prompt sentence string from Step 10. Server applies a model-specific tokenizer, which maps character sequences to subword tokens and then to numerical token identifiers. Server stores these identifiers in a fixed-length or variable-length array and may also generate an attention mask indicating valid token positions. Server outputs a tokenized prompt representation and any associated model input tensors required for inference.

### Step 12

Server executes the generative AI model to generate recipe-related text. As input, server uses the tokenized prompt representation from Step 11. Server loads model parameters (weight matrices and bias vectors) into memory and performs a sequence of linear transformations and attention computations layer by layer. In each transformer layer, server computes query, key, and value vectors, calculates attention scores using dot products, applies softmax normalization, and aggregates context vectors, followed by feed-forward networks with non-linear activations. Server repeats this for multiple layers and, at the output, derives a probability distribution over possible next tokens at each decoding step. Server runs a decoding algorithm, such as beam search or top-k sampling, to select tokens iteratively until an end-of-sequence token appears. Server outputs a generated token sequence representing the recipe title, ingredients, steps, substitutions, and flavor descriptions.

### Step 13

Server decodes the token sequence into human-readable text and segments the text into logical sections. As input, server uses the generated token sequence from Step 12. Server maps each token identifier back to its corresponding subword string and concatenates the subwords to form complete words and sentences. Server then applies text parsing rules, such as detecting numbered lists, headings, or special phrases that correspond to sections required by the prompt (for example, “Ingredients:” or “Steps:” or “Substitutions:”). Server splits the text into section strings, each representing a functional part of the recipe. Server outputs a set of labeled text sections for further structuring.

### Step 14

Server converts the labeled text sections into structured recipe data. As input, server uses the sectioned text from Step 13. Server analyzes the “Ingredients” section by splitting lines and applying pattern matching to extract ingredient names, quantities, and units, mapping ingredient names back to canonical identifiers when possible. Server analyzes the “Steps” section by splitting at numbered markers to form an ordered list of cooking steps. Server parses any “Substitutions” section to identify target ingredients, substitution candidates, and explanation phrases describing flavor changes. Server groups these parsed elements into a structured data object that includes fields such as title, ingredient list, step list, substitution list, and flavor notes. Server outputs this structured recipe data object.

### Step 15

Server performs validation and safety checks on the structured recipe data. As input, server uses the structured recipe data object from Step 14 together with the constraint vector and normalized ingredient vector. Server checks for consistency with dietary restrictions (for example, ensuring that a vegetarian recipe does not include meat identifiers), verifies that steps reference only defined ingredients, and flags any obviously unsafe cooking instructions, such as recommending undercooked items. Server may correct minor inconsistencies, such as normalizing units or merging duplicate ingredients. Server outputs a validated structured recipe data object ready for presentation.

### Step 16

Server formats the validated structured recipe data into a response payload for the terminal. As input, server uses the validated structured recipe data from Step 15. Server serializes the structured fields into a representation suitable for network transmission, assigns identifiers to recipes and substitutions, and adds auxiliary metadata such as timestamps and model version identifiers. Server assembles this information into a response message that preserves the hierarchy of title, ingredients, steps, substitutions, and flavor notes. Server outputs a formatted response payload and sends it to the terminal via the network interface.

### Step 17

Terminal receives the response payload from the server and reconstructs the structured recipe data. As input, terminal uses the serialized response payload transmitted in Step 16. Terminal parses the payload according to the agreed data format, recreates local data structures for the recipe title, ingredient entries, step entries, and substitution entries, and prepares these structures for user interface rendering. Terminal outputs internal UI data models reflecting the content of the structured recipe data.

### Step 18

Terminal renders the recipe content on the display and enables user interaction. As input, terminal uses the UI data models created in Step 17. Terminal draws the recipe title at a prominent location, displays the ingredient list with labels and quantities, and presents the step-by-step instructions in an ordered view. Terminal shows substitution options and flavor explanations in a dedicated section to differentiate them from the main steps. Terminal also activates interactive elements, such as buttons for requesting a milder or spicier version, or for switching to a different substitution candidate. Terminal outputs visual and interactive content to the user.

### Step 19

User reviews the displayed recipe, substitutions, and flavor notes, and optionally requests further refinement. As input, user observes the rendered information on the terminal and evaluates whether the proposal meets the desired conditions. User may enter new text, such as “make it less spicy and use only one pan,” or activate predefined adjustment controls. User produces updated constraints and instructions through these interactions. Terminal captures this updated input and outputs a refinement request message, which contains the new constraints and a reference to the previously generated recipe, back to the server.

### Step 20

Server processes the refinement request and generates an updated prompt sentence based on the existing structured data and the new constraints. As input, server uses the refinement request message from Step 19 and the original structured recipe data from earlier steps. Server merges the new constraints into the constraint vector, adjusts flags such as maximum spiciness or maximum number of cookware items, and regenerates intermediate textual components to reflect these changes. Server then constructs a revised prompt sentence that instructs the generative AI model to modify the previously generated recipe rather than create a new one from scratch. Server outputs this revised prompt sentence and proceeds through the same tokenization, generation, parsing, and formatting steps as in Steps 11 through 16 to produce an updated structured recipe, which is then returned to the terminal for display.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional recipe recommendation systems generally perform a simple mapping from a user query to a static recipe database or, at most, invoke a generative AI model using a coarse prompt derived from a textual order. Such systems typically suffer from several technical deficiencies in the way they process and structure heterogeneous input data and in the way they control generative AI output.

First, existing systems do not effectively integrate multiple heterogeneous input modalities—such as natural language text, structured ingredient data from a storage apparatus, and emotion-related audio and image data—into a unified, machine-usable context. As a result, the input to a generative AI model is often a loosely constructed prompt that fails to reflect the detailed user state, available resources, or emotional preferences, leading to unstable or irrelevant generated content. From a computing perspective, this means that the processor performs only shallow parsing and passes largely unstructured text downstream, which causes inefficient use of AI resources and requires significant manual interpretation at the user interface.

Second, conventional systems do not systematically control the output format and semantics of responses from a generative AI model. In many implementations, the model returns free-form text that is difficult for the processor to parse and validate automatically. This leads to brittle post-processing pipelines, error-prone extraction of ingredients and steps, and complex, ad hoc code for identifying missing ingredients or generating substitutions. The lack of a well-defined prompt structure and an expected output schema results in high variability and low reliability of system behavior.

Third, known approaches typically separate the analysis of available ingredients in a storage apparatus from the generation of recipe content. For example, the processor may first generate a recipe and then, in a separate stage, attempt to match required materials against a local list of available ingredients. This disjoint processing flow often produces recipes that are poorly aligned with actual availability, requires redundant iterations, and complicates the logic needed to construct substitute ingredient proposals or external ordering options. Technically, this results in inefficient data flows and duplicated computation across modules.

Fourth, systems that incorporate external supply or meal-providing services generally treat those services as loosely coupled add-ons. They do not exploit the structured output of a generative AI model to drive precise queries into external service data stores. Instead, they often rely on keyword-based or manual selection, which reduces the degree of automation and increases latency in the overall pipeline from user request to actionable ordering options. The technical problem to be solved by the present invention is therefore to improve computer processing in a recipe generation system by: (i) unifying multimodal user input, including emotion-related data, into structured context information; (ii) constructing precise, schema-constrained prompt sentences for a generative AI model based on that context; (iii) automatically transforming the model output into structured recipe information with explicit handling of insufficient ingredients and substitutions; and (iv) integrating this structured information with external service data stores to generate actionable, machine-usable proposal options. By addressing these issues, the invention aims to provide a more robust, efficient, and predictable end-to-end computing pipeline for intelligent meal proposal generation.

The specific processing by the specific processing unit 290 of the data processing device 12 in Application Example 2 is realized by the following means.

The present invention provides a server comprising a processor configured to communicate with a user terminal to acquire, via the user terminal, request information relating to a meal expressed in natural language and ingredient information relating to foodstuffs stored in a storage apparatus, to execute natural language processing on the natural language request information so as to identify structured request content including at least a type of dish, a taste preference, and a cooking purpose, to determine available ingredients based on the ingredient information, and to execute emotion analysis on audio and/or image data associated with the request information so as to estimate an emotional state of a user and to generate unified context information including the structured request content, the available ingredients, and the emotional state; the processor being further configured to construct, based on the unified context information, a prompt sentence for a generative AI model, the prompt sentence including a machine-interpretable instruction that specifies an output format comprising at least a dish name, a list of materials, procedure information, alternative material proposals, and hidden flavor proposals, to transmit the prompt sentence to the generative AI model and acquire, from the generative AI model, cooking procedure information output in accordance with the specified format, to compare material information included in the acquired cooking procedure information with the available ingredients to identify insufficient materials, to generate structured recipe information by adding substitute material information corresponding to the insufficient materials, and to transmit the structured recipe information to the user terminal for display as meal proposal information. This enables the computing system to transform heterogeneous user inputs and storage-apparatus data into a unified context, to drive a generative AI model with tightly controlled prompt sentences and expected output schemas, to automatically produce structured and availability-aware recipe data including substitutions, and to present machine-usable, actionable meal proposals with improved robustness, efficiency, and predictability compared to conventional systems.

The term “system” refers to an arrangement of one or more computing devices and associated components that cooperate to execute the processing described in the claims, including at least a server and a user terminal that communicate via a communication network.

The term “server” refers to an information processing apparatus including at least one processor, memory, and communication interface, configured to provide services such as analysis of user input, construction of prompt sentences, and interaction with a generative AI model.

The term “processor” refers to one or more hardware computation units, such as a central processing unit or a processing core in an integrated circuit, configured to execute machine-readable instructions to perform functions including natural language processing, emotion analysis, prompt sentence generation, and recipe information generation.

The term “user terminal” refers to an electronic device operated by a user, such as a portable information device or display-equipped computing device, including at least a display device and an input device, and configured to exchange information with the server.

The term “display device” refers to a hardware component that visually outputs information to a user, such as a liquid crystal display, an organic light-emitting display, or another image presentation apparatus.

The term “input device” refers to a hardware component that receives user operations, including but not limited to a touch-sensitive panel, a pointing device, a keyboard, a microphone, and a camera.

The term “storage apparatus” refers to a physical storage device or system, such as a refrigerator, freezer, pantry, or similar storage unit, in which foodstuffs or ingredients are stored, and may also encompass a data storage device that holds information about such foodstuffs.

The term “request information” refers to information relating to a desired meal, dish, or cooking outcome that is provided by a user, expressed at least in natural language and optionally including constraints, preferences, or contextual conditions.

The term “ingredient information” refers to data representing foodstuffs or materials that are stored in a storage apparatus, including at least identifiers or names of ingredients and optionally quantities, freshness, or categories.

The term “natural language processing” refers to a set of computational techniques executed by the processor for analyzing natural language text, including at least tokenization, morphological analysis, syntactic analysis, semantic analysis, or intent classification.

The term “request content” refers to structured information derived from request information by natural language processing, including at least a type of dish, a taste preference, and a cooking purpose or intent.

The term “type of dish” refers to a classification of a meal or recipe, such as a cuisine category, dish category, or preparation style, that is determined by processing the user's natural language request.

The term “taste preference” refers to user-desired taste characteristics, such as spicy, sweet, sour, mild, rich, or fresh, that are extracted from request information by natural language processing.

The term “cooking purpose” refers to a user's objective or context for preparing a meal, such as comfort, celebration, health orientation, quick preparation, or experimentation, identified from natural language request information.

The term “available ingredients” refers to those ingredients that are determined, based on ingredient information, to be present or usable from the storage apparatus at the time of processing.

The term “audio information” refers to digital data representing sounds captured from the user, including at least voice signals corresponding to the user's spoken requests or reactions.

The term “image information” refers to digital data representing visual scenes captured from the user, including at least images or video frames containing the user's face or expressions.

The term “emotion analysis” refers to computational processing applied to audio information and/or image information in order to infer or estimate an emotional state of the user, such as joy, sadness, excitement, or calmness.

The term “emotional state” refers to a qualitative or quantitative representation of the user's emotional condition, as classified or estimated by an emotion analysis process.

The term “context information” refers to aggregated and structured data that includes at least request content, available ingredients, and emotional state, and that is used as a basis for constructing a prompt sentence.

The term “generative AI model” refers to a machine learning model configured to generate text or other content in response to an input, including but not limited to a large-scale language model that produces cooking procedure information based on a prompt sentence.

The term “prompt sentence” refers to an instruction text constructed by the processor and supplied to a generative AI model, the instruction text describing the task to be performed by the model and optionally specifying an output format or constraints.

The term “cooking procedure information” refers to information describing how to prepare a dish, including at least a dish name, materials or ingredients, and step-by-step instructions for cooking.

The term “dish name” refers to a textual designation that identifies a particular meal or recipe generated or processed by the system.

The term “list of materials” refers to a structured enumeration of ingredients required for a dish, including at least names of ingredients and optionally their quantities or units.

The term “procedure information” refers to ordered instructions describing the steps to perform in preparing and cooking a dish.

The term “alternative material proposals” refers to suggestions for substitute ingredients that can be used in place of specific materials that are unavailable or insufficient.

The term “hidden flavor proposals” refers to suggestions for small quantities of additional materials or seasonings intended to enhance or deepen the flavor of a dish without dominating the primary taste.

The term “insufficient materials” refers to ingredients that are included in cooking procedure information but are not present, or are present in insufficient quantity, among the available ingredients determined from the storage apparatus.

The term “substitute material information” refers to data indicating one or more alternative ingredients that can replace insufficient materials, including at least an identifier or name of the substitute ingredient and optionally usage guidance.

The term “structured recipe information” refers to recipe-related data that the processor has organized according to a predefined structure or schema, including at least dish name, ingredients, procedure steps, and substitution-related information.

The term “meal proposal information” refers to information presented to the user that describes one or more candidate dishes, including structured recipe information and, optionally, associated ordering options or service links.

The term “existing meal menu” refers to information about a known dish or menu item that is specified or implied in the request information and that serves as a basis for generating modified cooking procedure information.

The term “modified cooking procedure information” refers to cooking procedure information that is generated by altering or extending an existing meal menu, such as by changing ingredients, flavor profile, or preparation steps.

The term “external providing apparatus” refers to an external system or service that provides at least one of foodstuffs or prepared meals, and that includes an information storage apparatus accessible by the server.

The term “information storage apparatus” refers to a data storage resource of an external providing apparatus, such as a database or data repository, that stores information about additional foodstuffs, products, or provided menus.

The term “foodstuff supply service” refers to a service that supplies raw or semi-processed ingredients to a user, such as a grocery supply, ingredient delivery, or meal kit delivery service.

The term “meal providing service” refers to a service that prepares and provides ready-to-eat dishes or meals to a user, such as a restaurant, catering, or meal delivery service.

The term “candidate information” refers to data representing one or more options of additional foodstuffs or provided menus that can be used to supplement insufficient materials identified in a recipe.

In one embodiment, a system includes a server, a terminal, at least one storage apparatus for foodstuffs, and at least one external providing apparatus. The server comprises at least one processor, a memory storing programs and parameter data, and a communication interface. The terminal comprises a display device, an input device, a microphone, and a camera, and is implemented, for example, as a smartphone, tablet, or other portable information processing device. The storage apparatus is implemented, for example, as a refrigerator or similar equipment equipped with an identification mechanism (such as a barcode reader or weight sensor) and an associated data store that holds ingredient information. The external providing apparatus includes a database of products or menus and a network interface for communication with the server.

The server executes application software implemented, for example, in a general-purpose programming language running on an operating system. The server uses software libraries for natural language processing, such as a tokenization and part-of-speech tagging library, and uses emotion analysis libraries or external emotion-recognition services. The server also communicates with a generative AI model, implemented, for example, as a large-scale language model accessible over a network. The generative AI model is configured as a multi-layer neural network with an attention-based architecture, trained on large corpora of text using a sequence-to-sequence objective and a cross-entropy loss function, and updated by gradient-based optimization. The model parameters are fixed at deployment time, and the server adjusts the model behavior dynamically by varying prompt sentences and control parameters such as temperature, top-k sampling, and maximum output length.

The terminal provides a graphical user interface that allows the user to input, in natural language, request information relating to a meal, including a desired type of dish, taste preference, and cooking purpose, as well as constraints such as available time or dietary restrictions. The terminal also acquires ingredient information by receiving, from a local application or from the storage apparatus over a local network, identifiers of foodstuffs currently stored, such as names and quantities. The terminal captures audio information and image information associated with the request, such as the user's spoken utterance and facial expression, by controlling the microphone and the camera. The terminal transmits the collected request information, ingredient information, audio data, and image data to the server as structured data through the communication interface.

The server stores the received information in memory using structured data objects. For example, the server represents request information as a record including fields for raw text, language code, time stamp, and terminal identifier. The server represents ingredient information as a list of ingredient records, each having normalized names, category labels, and availability flags. The server represents audio and image data by references to stored binary objects and associated metadata such as sampling rate and resolution. By normalizing all inputs into these specific data structures, the server can perform deterministic and optimized processing pipelines without relying on ad hoc text parsing after the fact.

The server executes natural language processing on the natural language portion of the request information. The server converts the raw text into a sequence of tokens, assigns part-of-speech tags, and constructs a dependency parse. The server then applies trained classifiers, such as a linear classifier or a small neural network, that map features derived from the tokens and tags to semantic categories, including dish type, taste preference, and cooking purpose. For example, the server detects tokens such as “pasta” and “Italian” and classifies the request as an Italian pasta dish; the server detects adjectives such as “spicy”, “creamy”, or “fresh” and maps them to structured taste preference features.

The server performs emotion analysis on the audio information and image information. The server extracts audio features such as Mel-frequency cepstral coefficients, pitch contours, and energy levels, and extracts image features such as facial landmarks and expression descriptors. The server then inputs these features into an emotion recognition model, which may be a convolutional neural network for images and a recurrent or transformer-based network for audio. The emotion recognition model has been trained on labeled datasets of voice and facial expressions to minimize a loss function that represents the classification error over predefined emotion categories. The server obtains from this model an estimated emotional state such as joy, sadness, excitement, or calmness, represented as a probability distribution and a selected primary label.

The server merges the outputs of natural language processing, ingredient normalization, and emotion analysis into unified context information. The unified context information is a data structure including, in a normalized form, the identified dish type, taste preference, cooking purpose, available ingredients, and emotional state. The server uses a deterministic schema to ensure that each element of the context is stored in known fields, enabling subsequent processing to be executed without re-parsing free-form data.

The server constructs a prompt sentence for the generative AI model based on the unified context information. The server uses template-based generation, in which the server fills pre-defined slots in a prompt template with context items, and also uses rule-based modifications depending on the inferred intent. The server explicitly specifies in the prompt sentence the desired output format, including fields such as the dish name, list of materials, procedure information, alternative material proposals, and hidden flavor proposals.

The server generates, for example, a prompt sentence such as:

“The user wants to eat spicy pasta. The refrigerator contains tomato and cheese. The user's emotion is joy. Act as a professional chef. Propose one original spicy pasta recipe that uses tomato and cheese. Include: (1) recipe title, (2) ingredient list with approximate amounts, (3) step-by-step cooking instructions, and (4) one hidden flavor suggestion to deepen the taste. If typical Italian herbs like basil are not available, please propose alternatives such as parsley. Output the result in a clearly structured, labeled textual format so that each section (title, ingredients, steps, hidden flavor, substitutions) is easily identifiable.”

The server may also generate, for another example, a prompt sentence such as:

“The user's emotion is joy. The user's order is: ‘I want something fresh today.’ The refrigerator contains tomato, lettuce, and cucumber. Please propose a creative, refreshing recipe that matches a joyful mood. Include the recipe title, ingredients with approximate amounts, detailed steps, and one hidden flavor to enhance freshness. Provide the output in sections labeled: Title, Ingredients, Steps, Hidden Flavor.”

The server then transmits the prompt sentence, together with control parameters (such as decoding strategy parameters), to the generative AI model over a network. The generative AI model performs forward propagation through its transformer-based architecture, computing attention-weighted representations over the tokenized prompt, and predicts output tokens sequentially. Because the prompt sentence clearly describes required sections and constraints, the model produces text with labeled sections that the server can parse deterministically. This controlled prompting differs from human manual recipe writing in that the model is forced, by the prompt design, to adhere to a machine-interpretable structure, thereby reducing ambiguity and variation and enabling downstream algorithmic processing.

The server receives the generated text and parses it using pattern-based and rule-based algorithms. For example, the server identifies section headers such as “Title:”, “Ingredients:”, “Steps:”, “Hidden Flavor:”, and “Substitutions:”, and splits the text accordingly. The server maps each section into corresponding fields of structured recipe information. The server then maps each ingredient name back into the normalized ingredient database, using synonym tables and ontology mapping. The server compares the required ingredients with the available ingredients to determine which materials are insufficient. The server consults a substitution table stored in the memory, specifying substitution rules such as “basil→parsley” or “mozzarella→tofu”, where each rule associates an original ingredient with one or more substitute ingredients and includes conditions and ratios.

The server attaches substitute material information to the structured recipe information, including, for each insufficient material, one or more substitute ingredients and optional guidance such as “use half the amount of parsley compared to basil.” Because the model output is structured and the substitution table is algorithmically applied, the server can guarantee consistent handling of insufficiencies without human intervention. The server may also annotate the structured recipe information with availability flags for each ingredient, enabling the terminal to visually distinguish between ingredients present in the storage apparatus and those that require acquisition.

The server interacts with external providing apparatuses to obtain, based on the structured recipe information and insufficient materials, candidate options for additional foodstuffs or prepared meals. The server composes machine-readable queries that include normalized ingredient identifiers, quantities, and optional constraints such as price or delivery time. The server sends these queries to product or menu databases of the external providing apparatuses and receives matching records. The server attaches the retrieved candidate information, such as product names, menu names, prices, and ordering links, to the structured recipe information. Because the recipe information is already normalized and structured, the mapping from missing materials to external products or menus can be performed using direct field comparisons rather than approximate keyword matching, which reduces computational overhead and increases matching precision.

The terminal receives the structured recipe information and candidate information from the server and renders it on the display device in a manner that guides the user through cooking or ordering. The terminal displays the dish name, the ingredient list with availability indicators and substitution suggestions, the procedure steps, and the hidden flavor proposals in separate areas. The terminal also provides interactive elements that allow the user to select substitute ingredients, to revise preferences, or to order missing materials or meals from the external providing apparatuses. The terminal supports incremental updates, so that changes requested by the user can be sent back to the server for regeneration of prompt sentences and recipe content.

The server and the generative AI model together implement processing that goes beyond simple automation of human tasks. The use of unified context information, structured prompt sentences, and schema-constrained outputs reduces the number of network round-trips between the server and the generative AI model, because the server can obtain correctly structured data in a single or reduced number of calls. This reduction in calls results in lower communication load and faster response times. The deterministic parsing of labeled sections and the use of normalized data structures enable the server to avoid expensive text-mining operations on unstructured output, thereby improving computational efficiency and reducing error rates during extraction of ingredients and steps.

The integration of emotion analysis into the unified context information also improves the technical performance of the generative AI model. By explicitly encoding the emotional state as a parameter in the prompt sentence, the server biases the generative AI model toward a subset of its parameter space tuned to particular tone and style of recipes. This reduces the variance of generated outputs across similar inputs and increases the likelihood that a single prompt produces outputs conforming to the desired style. As a result, the server requires fewer retries and less post-processing to obtain acceptable outputs, thereby improving processing throughput and reducing computational cost.

The server controls the generative AI model and the emotion recognition model using explicit thresholds and rules implemented in software. For example, the server may set a threshold probability for emotion classification, below which the emotional state is treated as neutral; the server may select prompt templates based on combinations of dish type and emotional state, and may adjust decoding parameters of the generative AI model accordingly. These rule-based controls constitute specific, non-conventional combinations of pattern recognition and rule evaluation that are implemented at the processor level to improve the behavior of the overall system.

In another embodiment, the server uses an alternative generative AI model architecture, such as an encoder-decoder transformer or a recurrent neural network with attention, trained specifically on cooking-related corpora. The server may fine-tune the model by supplying training pairs consisting of prompt sentences and desired structured recipe outputs, and by optimizing a loss function that penalizes deviations from a target schema and from desired ingredient substitution patterns. The server updates the model parameters during training by performing backpropagation and gradient descent over batched examples, and then deploys the fine-tuned model for inference with fixed parameters. This embodiment enhances the system's ability to generate outputs that align closely with the internal data schema and substitution rules used by the server, thereby further reducing parsing errors and increasing technical robustness.

In another embodiment, the server executes a caching mechanism where previously generated structured recipe information is stored in a cache keyed by normalized context information. When a new request arrives with similar context information, the server retrieves the cached structured recipe information instead of invoking the generative AI model again. The server uses similarity metrics defined over the structured context fields, such as cosine similarity over embedding vectors, to decide whether a cache hit is acceptable. This caching technique reduces repeated inference calls, lowers network traffic, and accelerates response times for repeated or similar requests.

In another embodiment, the storage apparatus incorporates sensors and an embedded controller that periodically measure quantities or detect presence of foodstuffs and send updated ingredient information to the server. The server maintains a continuously updated model of available ingredients, which enables more accurate identification of insufficient materials and more precise substitution and ordering decisions. This configuration creates a closed loop in which physical state changes in the storage apparatus are reflected in digital ingredient information, which in turn affects computation of recipes and ordering options.

In all embodiments, the server, the terminal, and the generative AI model cooperate through precisely defined data structures, non-conventional prompt sentence designs, and algorithmic rules governing emotion analysis, ingredient normalization, and substitution logic. These technical arrangements improve the way in which computing resources are used for personalized meal proposal generation, increasing processing speed, accuracy, and reliability relative to systems that simply forward unstructured user text to a model and present the model's raw, unstructured output.

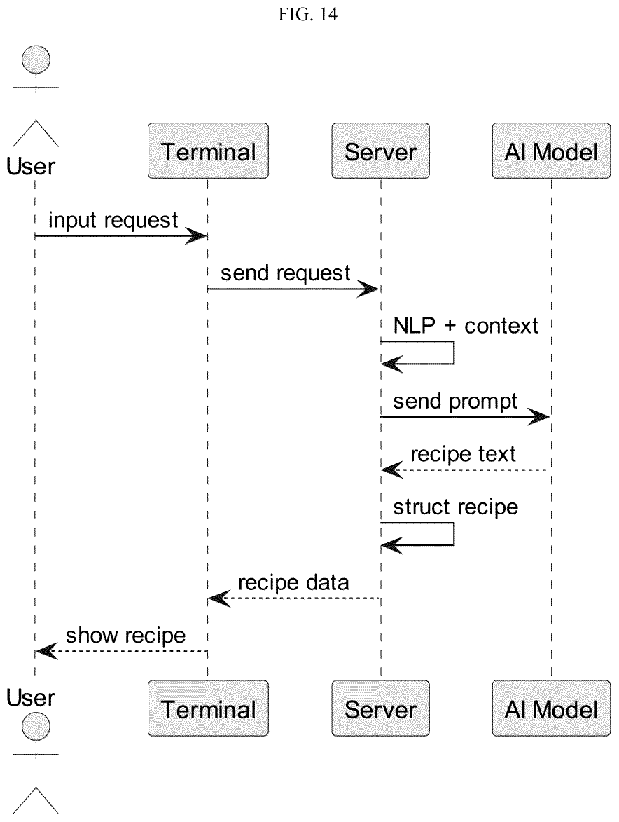

The following describes the processing flow using FIG. 14.

### Step 1

User operates the terminal to input request information.

User enters, via a text input field or speech interface on the terminal, natural language describing a desired meal, such as “I want spicy pasta” or “I want something fresh today.” User may additionally input contextual information, such as “I only have tomato and cheese in the fridge,” and may allow the terminal to capture audio and image data using the microphone and camera.

Input: Free-form natural language text (or speech), optional auxiliary text about ingredients, and optional raw audio/image signals.

Output: A logical request object inside the terminal that contains text data, optional ingredient text, and references to captured audio/image streams.

### Step 2

Terminal structures and transmits the user request to the server.

Terminal converts the logical request object into a structured data format (for example, a JSON-like internal object) including fields such as ‘order_text’, ‘fridge_text’, timestamps, and device identifiers. Terminal associates the raw audio and image data with this object by file paths or binary attachments. Terminal then sends this structured request to the server via a network protocol such as HTTPS.

Input: User request object containing natural language text, optional ingredient text, and audio/image references.

Output: A network message transmitted to the server containing structured request information and associated media data.

### Step 3

Server receives and stores the request data.

Server, via a communication interface, accepts the incoming network message from the terminal and decodes the structured data. Server validates mandatory fields, such as checking that ‘order_text’ is present or that audio is available if speech-only input was used. Server writes the received data into memory structures and optionally persists it into a database, associating it with a session identifier.

Input: Structured request data from the terminal and associated media data.

Output: Internal server-side data structures (for example, request records) that hold the raw text, ingredient text, audio and image references, and metadata.

### Step 4

Server performs speech-to-text conversion when needed.

Server determines whether the ‘order_text’ field is missing or incomplete and whether audio data is available. When speech-only input is detected, server sends the audio data to a speech recognition module or an external speech-to-text service. Server receives a textual transcription of the audio and inserts this text into the request record.

Input: Audio data representing user speech and metadata describing encoding and language.

Output: A complete ‘order_text’ string stored in the request record, enabling subsequent text-based processing.

### Step 5

Server executes natural language processing on the request text.

Server applies a natural language processing pipeline to the ‘order_text’, including tokenization, part-of-speech tagging, and dependency parsing. Server extracts semantic features such as dish type, cuisine, taste preference, and cooking purpose by applying rule sets and trained classifiers. For example, server maps “spicy” to a taste preference flag and “pasta” to a dish type category.

Input: Request text stored in ‘order_text’.

Output: Structured request content data, including fields such as dish type, taste preference, cuisine, and cooking purpose.

### Step 6

Server normalizes ingredient information and determines available ingredients.

Server analyzes the ingredient-related text (for example, “I have only tomato and cheese in the fridge”) or ingests ingredient data directly from the storage apparatus. Server normalizes ingredient names by lowercasing, handling plurals, and consulting an ingredient dictionary to map variations (for example, “tomatoes”→“tomato”). Server creates a list of available ingredients, each with a normalized name and an internal identifier.

Input: Ingredient-related text and/or structured ingredient data from the storage apparatus.

Output: A normalized list of available ingredients with internal identifiers and basic attributes.

### Step 7

Server performs emotion analysis on audio and image data.

Server checks whether emotion analysis is enabled and whether audio or image data is available in the request record. Server extracts audio features and image features and feeds these features into an emotion recognition model, such as a neural network trained on labeled emotion data. Server obtains a probability distribution over emotion categories and selects a primary emotional state (for example, “joy” or “sadness”).

Input: Audio signals, image frames, and associated feature extraction parameters.

Output: An estimated emotional state label and confidence scores stored as part of the request context.

### Step 8

Server constructs unified context information.

Server aggregates the outputs of natural language processing, ingredient normalization, and emotion analysis into a unified context structure. This structure holds, in distinct fields, the dish type, taste preference, cooking purpose, available ingredients, and emotional state.

Server ensures that all data is represented in a normalized, machine-usable form according to a defined schema.

Input: Structured request content data, normalized ingredient list, and emotion analysis result.

Output: Unified context information object that summarizes the current request in a structured and comprehensive manner.

### Step 9

Server determines initial insufficiencies and candidate substitutions.

Server compares typical ingredient sets associated with the identified dish type and taste preference against the available ingredients from the unified context. Server identifies potentially missing but commonly used ingredients (for example, “garlic” or “basil”) and consults a substitution rule base that specifies alternative ingredients (for example, “basil→parsley”).

Input: Unified context information object and ingredient rule base.

Output: A preliminary list of potentially missing ingredients and their candidate substitutes stored within the context.

### Step 10

Server generates a prompt sentence for the generative AI model.

Server uses template rules and the unified context to compose a prompt sentence that describes the required output clearly. Server includes fields such as dish type, taste preference, available ingredients, emotional state, and output format requirements. For example, server produces a prompt sentence such as:

“The user wants to eat spicy pasta. The refrigerator contains tomato and cheese. The user's emotion is joy. Act as a professional chef. Propose one original spicy pasta recipe that uses tomato and cheese. Include: (1) recipe title, (2) ingredient list with approximate amounts, (3) step-by-step cooking instructions, and (4) one hidden flavor suggestion to deepen the taste. If typical Italian herbs like basil are not available, please propose alternatives such as parsley. Output the result in clearly labeled sections: Title, Ingredients, Steps, Hidden Flavor, Substitutions.”

Input: Unified context information and prompt template definitions.

Output: A fully formed prompt sentence string ready to be supplied to the generative AI model.

### Step 11

Server submits the prompt sentence to the generative AI model and obtains generated content.

Server packages the prompt sentence and associated generation parameters (such as maximum output length and temperature) and sends them to the generative AI model via a network call or a local invocation interface. The model performs forward computation through its neural network architecture and returns generated text that follows the requested structure. Server receives the generated text response and stores it as raw model output.

Input: Prompt sentence and generation parameters.

Output: Generated text from the generative AI model that purportedly includes sections for title, ingredients, steps, hidden flavor, and substitutions.

### Step 12

Server parses and structures the generated recipe information.

Server scans the generated text to identify labeled sections, such as lines beginning with “Title:” or “Ingredients:”. Server splits the text into segments corresponding to each section, and for the ingredients and steps, server further parses lines into individual items and instructions. Server populates a structured recipe object with fields for dish name, list of ingredients (with names and amounts), procedure steps, hidden flavor proposals, and substitution suggestions.

Input: Raw generated text produced by the generative AI model.

Output: Structured recipe information object where each recipe element is stored in a corresponding field according to a predefined schema.

### Step 13

Server identifies actual insufficient materials and attaches concrete substitution data.

Server compares the list of ingredients in the structured recipe information with the normalized list of available ingredients. Server determines which recipe ingredients are not present in the available set or are marked as insufficient. For each such ingredient, server consults the substitution rule base to retrieve one or more substitute options and related usage instructions. Server then adds substitution data entries to the recipe object, marking each ingredient with its availability and listing any substitutes.

Input: Structured recipe information object, normalized available ingredient list, and substitution rule base.

Output: Enhanced structured recipe information object in which each ingredient is annotated with availability status and optional substitute ingredient data.

### Step 14

Server integrates external supply and meal-providing options.

Server interprets the enhanced structured recipe information to derive a list of missing or insufficient ingredients and a summary of the recipe type. Server composes queries to the data storage of external providing apparatuses, including normalized ingredient identifiers and optional constraints such as required quantities. Server receives matching products or menus and attaches these as candidate options for additional foodstuffs or ready-made meals, associating each with identifiers, prices, and ordering links.

Input: Enhanced structured recipe information and external service data interfaces.

Output: Structured recipe information supplemented with candidate external supply options and meal-providing options.

### Step 15

Server transmits the final recipe and options to the terminal.

Server packages the enhanced structured recipe information, including annotated ingredients, procedure steps, hidden flavor proposals, substitution suggestions, and external candidate options, into a response message. Server sends this response back to the terminal via the communication interface.

Input: Final enhanced structured recipe information object.

Output: A network response containing fully processed recipe data and related options delivered to the terminal.

### Step 16

Terminal renders the recipe and interactive options for the user.

Terminal receives the response message and parses the structured data into internal UI models. Terminal displays the dish title, ingredient list with visual indicators of availability, substitution hints, and the cooking steps on the display device. Terminal also presents action controls allowing the user to accept substitutions, request regeneration, or initiate ordering of missing materials or prepared meals through external services.

Input: Response message containing structured recipe data and external options.

Output: A graphical display of the recipe and controls, enabling the user to view, interact with, and act upon the meal proposal.

### Step 17

User reviews the proposal and selects a course of action.

User examines the displayed recipe, including the hidden flavor suggestion and substitution proposals, and decides whether to cook the dish, order missing ingredients, or select a ready-made menu. User inputs selections or feedback through the terminal controls, such as tapping a button to order a specific product or menu, or to request a modified recipe.

Input: Displayed recipe information and on-screen controls.

Output: User commands and feedback events that can be transmitted back to the server for further processing, logging, or regeneration.

### Step 18

Server processes user feedback and updates internal control logic.

Server receives user commands and feedback events from the terminal and logs them together with the original unified context and recipe information. Server analyzes patterns over time, such as frequently rejected substitutions or frequent requests for a milder flavor, and adjusts prompt templates, substitution rules, or generation parameters accordingly. This analysis may be executed offline or periodically.

Input: User feedback data and historical context/recipe records.

Output: Updated prompt sentence templates, rule sets, or generation parameter configurations that refine future processing and improve system behavior.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

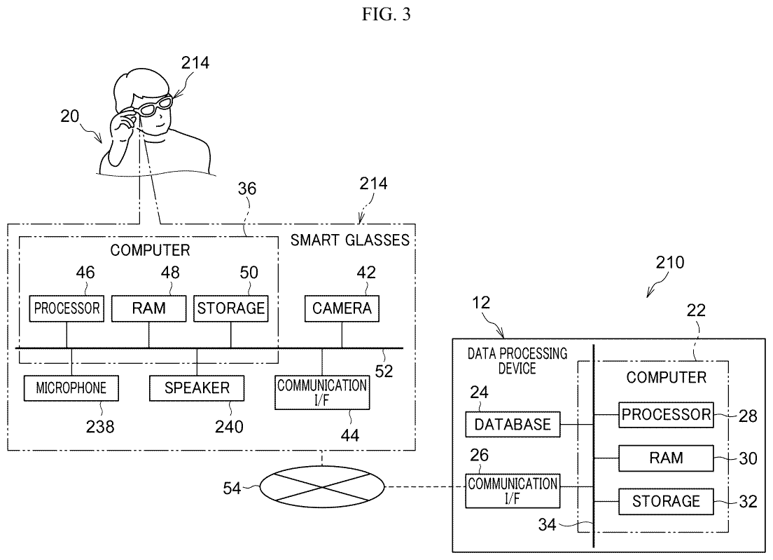

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

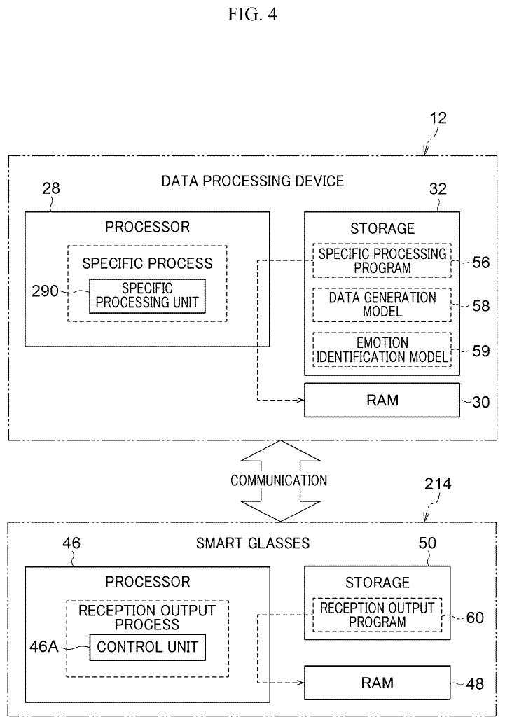

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

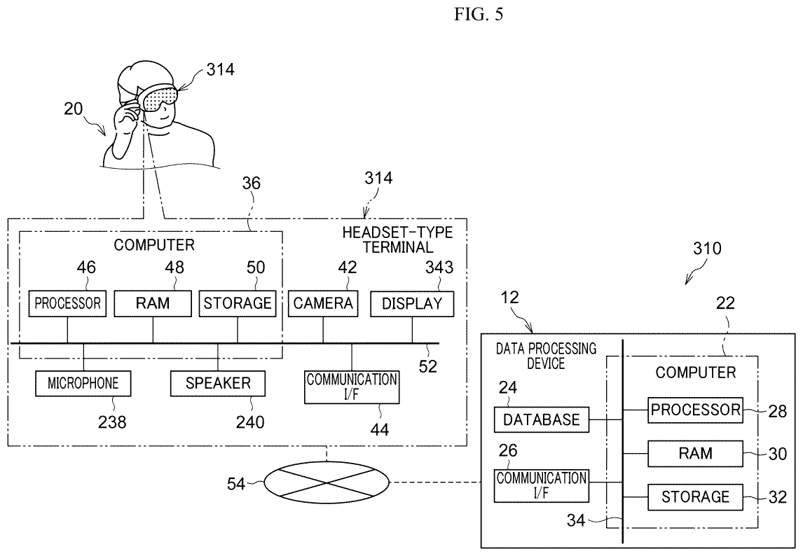

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

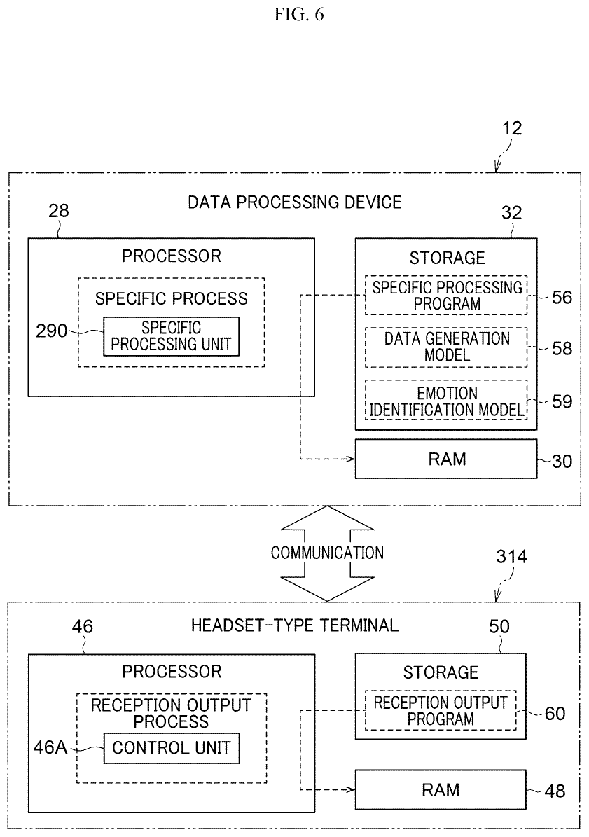

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

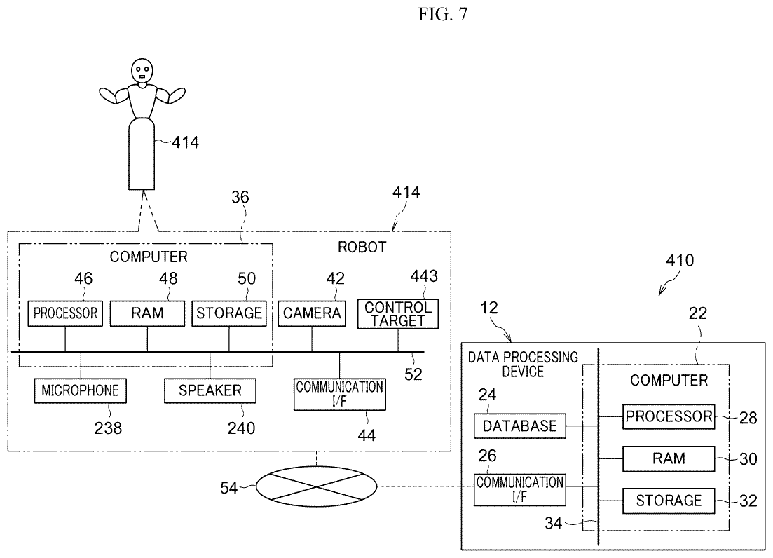

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

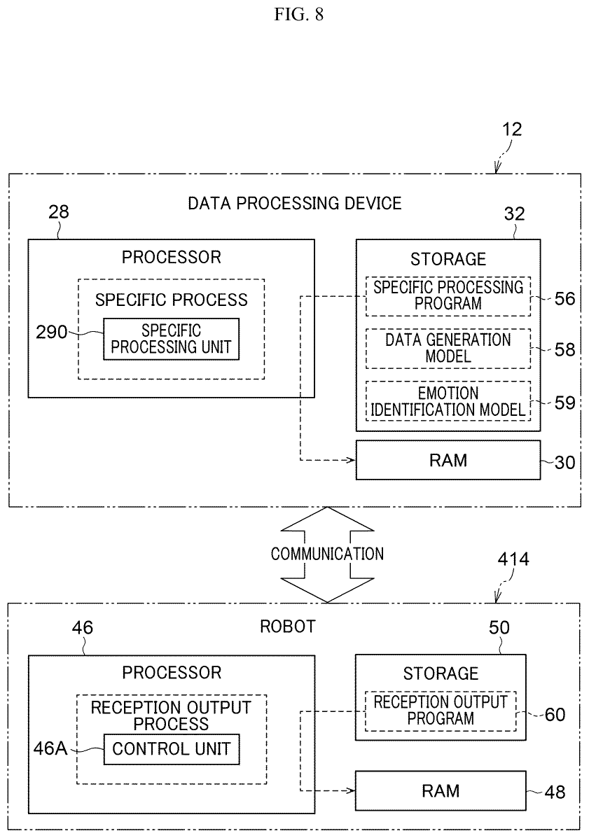

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

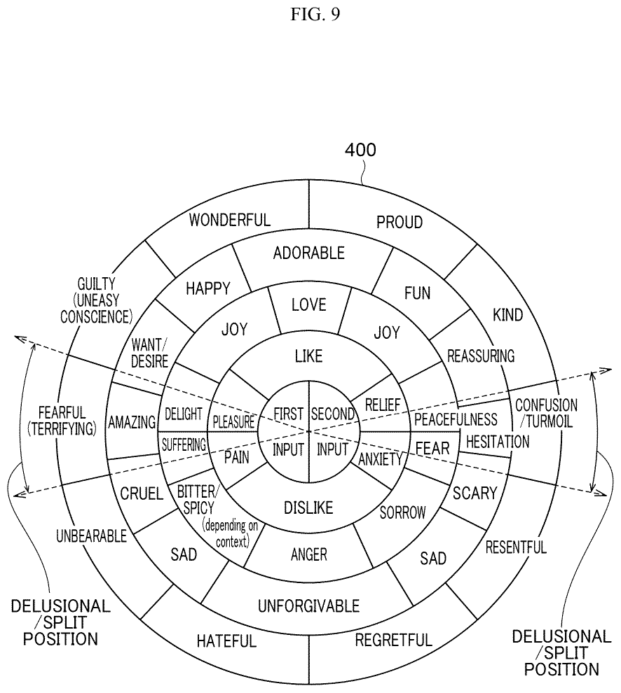

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

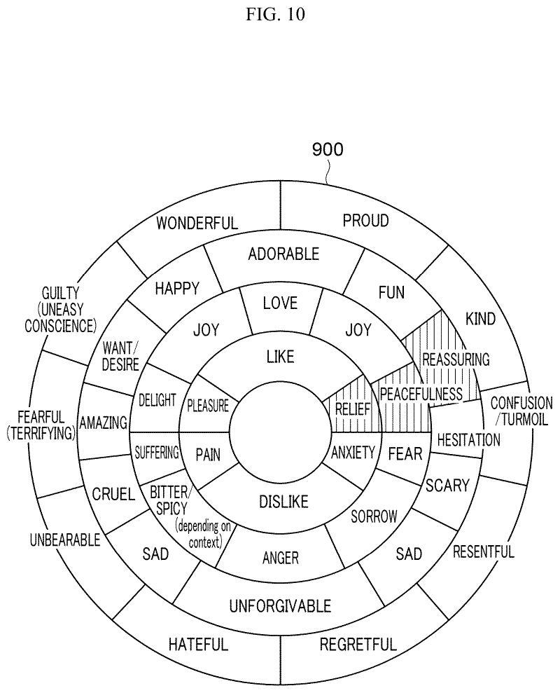

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
provide an information input/output unit including a display device and an input device, the information input/output unit being configured to receive, from a user, a prompt sentence representing a request related to a cooking activity,
analyze the prompt sentence acquired via the information input/output unit by using a natural language processing method to generate analysis data by dividing the prompt sentence into morpheme units or phrase units and identifying, based on part-of-speech information and dependency relations, at least a taste preference, a cooking target, available ingredients, time conditions, and a meal category,
generate, by using the analysis data, a prompt sentence that instructs a generative language processing model to generate a cooking proposal or a cooking procedure, and reconstruct the prompt sentence into an input format for the generative language processing model,
transmit the prompt sentence generated for the generative language processing model to an external generative language processing model and acquire, as recipe information, a cooking proposal result received from the generative language processing model, and
convert the recipe information acquired from the generative language processing model into structured data including at least a dish name, ingredient information, and step information, and edit the structured data into a display format that is presentable to the user via the information input/output unit.

### Supplementary 2

The system according to supplementary 1,
wherein the processor is configured to
extract, by the analysis of the prompt sentence, an existing dish name and modification conditions included in the prompt sentence, and, based on analysis data including the existing dish name and the modification conditions, generate a prompt sentence that instructs the generative language processing model to generate an arrangement recipe obtained by modifying the existing dish.

### Supplementary 3

The system according to supplementary 1,
wherein the processor is configured to
acquire ingredient information from a storage device or from an external device, identify, based on the prompt sentence and the ingredient information, a missing ingredient, and, based on analysis data including the missing ingredient and the available ingredients, generate a prompt sentence that causes the generative language processing model to propose a substitute candidate for the missing ingredient or a substitute recipe.

### Application Example 1

### Supplementary 1

A system comprising a processor, a memory, and a communication interface, wherein the processor is configured to
receive, via the communication interface, order data including natural language order information and user identification information from an information terminal operated by a user, and read, from the memory, history information and preference information for each user,
apply a natural language processing algorithm to the received order information to perform tokenization and category classification, and specify intent information indicating whether the order information corresponds to at least one of new recipe generation, existing recipe arrangement, ingredient substitution proposal, hidden flavor proposal, and mood- or preference-based dish proposal,
integrate a plurality of attribute information including the intent information, the history information, the preference information, and ingredient possession information of the user, and generate, based on a template, a prompt sentence used as input to a generative AI model, the prompt sentence including at least a requested task, an output format, and constraint conditions,
input the prompt sentence to the generative AI model and cause the generative AI model to execute probabilistic text generation processing to generate dish proposal data including at least one of a dish name, an ingredient list, amount information, cooking steps, ingredient substitution candidates, and hidden flavor candidates,
extract dish configuration information from the dish proposal data, and compare the dish configuration information with recipe information and menu provision information of a service provider stored in the memory, to specify at least one of alternative ingredient candidates, menu candidates corresponding to or similar to the dish, and delivery availability information, and
transmit the dish proposal data and the menu candidates to the information terminal, receive order confirmation information from the information terminal, transmit delivery request data for the menu candidates to an external delivery management system based on the order confirmation information, receive delivery status information from the external delivery management system, and notify the information terminal of the delivery status information.

### Supplementary 2

The system according to supplementary 1,
wherein the processor is configured to
search, in the memory, existing recipe information, extract reference recipe data corresponding to a dish name or dish attribute included in the order information, include the reference recipe data in the prompt sentence, and cause the generative AI model to generate arrangement recipe data including at least one of flavor modification, nutritional value adjustment, and simplification of cooking steps with respect to the reference recipe data.

### Supplementary 3

The system according to supplementary 1,
wherein the processor is configured to
acquire, from the memory, ingredient information stored as ingredient possession information of the user and indicating ingredients held in a cold storage apparatus, compare required ingredient information included in candidate recipe data with the ingredient possession information to specify missing ingredient information, and input a prompt sentence including the missing ingredient information and the ingredient possession information to the generative AI model to generate proposal information including at least one of substitute ingredient candidates for the missing ingredient information and hidden flavor candidates.

### Example 2

### Supplementary 1

A system comprising a processor,
wherein the processor is configured to
receive, from a user terminal, cooking-related preference conditions and information on available ingredients,
analyze the received preference conditions and ingredient information by using natural language processing to identify at least a type of dish, a dietary restriction, a flavor preference, a shortage ingredient, and a degree of ambiguity of a user request, generate a prompt sentence, based on the identified type of dish, dietary restriction, flavor preference, shortage ingredient, necessity of proposing a substitution for the shortage ingredient, necessity of presenting multiple options for an ambiguous request, and an output-format condition, the prompt sentence being configured to instruct a generative AI model to generate at least a cooking procedure, a modification of an existing dish, a substitution proposal for an ingredient, and a flavor proposal,
input the generated prompt sentence to the generative AI model, and obtain, from the generative AI model, cooking procedure information, modification recipe information, ingredient substitution information, and flavor proposal information, and
convert the obtained cooking procedure information, modification recipe information, ingredient substitution information, and flavor proposal information into structured data including at least a cooking step, an ingredient list, a substitution candidate, and a flavor description, and format the structured data into a presentation format for the user terminal.

### Supplementary 2

The system according to supplementary 1,
wherein the processor is configured to
receive, from the user terminal, information on an existing dish and a change condition, acquire, from a storage device, a standard ingredient configuration and a standard cooking procedure corresponding to the existing dish, and generate a prompt sentence, based on a difference between the change condition and the standard ingredient configuration and the standard cooking procedure, the prompt sentence being configured to instruct the generative AI model to generate a modification recipe of the existing dish.

### Supplementary 3

The system according to supplementary 1,
wherein the processor is configured to
acquire ingredient information stored in a storage apparatus, identify a shortage ingredient by comparing the ingredient information with a standard ingredient configuration stored in a recipe database, generate a prompt sentence configured to instruct the generative AI model to present, for each identified shortage ingredient, a substitution ingredient candidate and an explanation of a flavor change caused by the substitution ingredient candidate, and include the substitution ingredient candidate and the explanation of the flavor change, generated by the generative AI model, in the structured data.

### Application Example 2

### Supplementary 1

A system comprising a processor,
wherein the processor is configured to
communicate with a user terminal including a display device and an input device, and to acquire, via the user terminal, request information relating to a meal expressed in natural language and ingredient information relating to foodstuffs stored in a storage apparatus, to execute natural language processing on a natural language text included in the request information so as to identify request content including a type of dish, a taste preference, and a cooking purpose, to identify available ingredients based on the ingredient information relating to the foodstuffs stored in the storage apparatus, and to execute emotion analysis based on audio information and image information so as to estimate an emotional state of a user, thereby generating context information including the request content, the available ingredients, and the emotional state,
to construct, based on the context information, a prompt sentence for a generative AI model, the prompt sentence instructing the generative AI model to generate cooking procedure information for a dish, and including an instruction defining an output format specifying at least a dish name, a list of materials, procedure information, alternative material proposals, and hidden flavor proposals,
to transmit the prompt sentence to the generative AI model, to acquire the cooking procedure information for the dish from the generative AI model, to compare material information included in the acquired cooking procedure information with the available ingredients so as to identify insufficient materials, and to generate structured recipe information by adding substitute material information corresponding to the insufficient materials, and
to transmit the recipe information to the user terminal so that the recipe information is displayed as meal proposal information on the user terminal.

### Supplementary 2

The system according to supplementary 1,
wherein the processor is configured to, when the request information includes information relating to an existing meal menu, generate, based on the context information, a prompt sentence instructing the generative AI model to generate modified cooking procedure information for the existing meal menu, and to present, as the recipe information, the modified cooking procedure information acquired from the generative AI model on the user terminal.

### Supplementary 3

The system according to supplementary 1,
wherein the processor is configured to refer to information stored in an information storage apparatus of an external providing apparatus that provides at least one of a foodstuff supply service and a meal providing service, to acquire, based on the recipe information, candidate information relating to at least one of additional foodstuffs and provided menus for supplementing the insufficient materials, and to present the candidate information in association with the recipe information on the user terminal.

What is claimed is:

1. A system comprising:
circuitry configured to
receive, via a communication interface coupled to a packet-switched network, a natural-language input from a terminal device,
analyze the natural-language input using a natural language processing method comprising tokenization, part-of-speech tagging, and dependency parsing to generate analysis data, the analysis data comprising identified attributes including at least a target category, a preference attribute, one or more constraint conditions, and available resource items,
construct, based on the analysis data, a task-specific prompt sentence that specifies a requested generation task, an output format, and the constraint conditions, the task-specific prompt sentence being formatted as structured input for a generative neural network model,
transmit the task-specific prompt sentence to the generative neural network model and receive, from the generative neural network model, generated content data produced in response to the task-specific prompt sentence,
convert the generated content data into structured output data comprising at least a title field, a resource list field, and a sequential procedure field by applying pattern-based extraction to the generated content data, and
transmit the structured output data to the terminal device for presentation on a display of the terminal device.

2. The system according to claim 1, wherein the analysis data further comprises a classification of the natural-language input into one of a plurality of intent categories, each intent category corresponding to a distinct generation task, and the circuitry selects a prompt template from a plurality of stored prompt templates based on the classified intent category.

3. The system according to claim 2, wherein the plurality of intent categories includes at least new content generation, modification of existing content, resource substitution proposal, and preference-based content proposal.

4. The system according to claim 3, wherein the circuitry is further configured to, when the classified intent category corresponds to modification of existing content, extract from the natural-language input an existing content identifier and one or more modification conditions, retrieve reference content data associated with the existing content identifier from a storage device, and include the reference content data and the modification conditions in the task-specific prompt sentence.

5. The system according to claim 4, wherein the circuitry is further configured to, when the classified intent category corresponds to resource substitution proposal, compare resource items required by the reference content data with the available resource items to identify missing resource items, and include the missing resource items in the task-specific prompt sentence to instruct the generative neural network model to propose substitute candidates for each missing resource item.

6. The system according to claim 5, wherein the generated content data includes, for each substitute candidate, an explanation of a characteristic change resulting from the substitution relative to an original resource item.

7. The system according to claim 1, wherein the circuitry is further configured to receive, from a storage device or from an external device via the communication interface, resource inventory data indicating types and quantities of resource items currently available, and to include the resource inventory data in the analysis data prior to constructing the task-specific prompt sentence.

8. The system according to claim 7, wherein the circuitry is further configured to compare resource items specified in the generated content data with the resource inventory data to identify missing resource items, and to generate a supplemental prompt sentence instructing the generative neural network model to propose substitute resource items for the missing resource items.

9. The system according to claim 1, wherein the natural language processing method further comprises named entity recognition to extract mentions of specific items, quantity expressions, and temporal expressions from the natural-language input, and the circuitry maps extracted entities to corresponding attribute fields in the analysis data using a rule-based classifier operating on the dependency parsing result.

10. The system according to claim 9, wherein the circuitry is further configured to detect a degree of ambiguity in the natural-language input based on a count of unresolved attribute fields in the analysis data, and when the degree of ambiguity exceeds a threshold, to include in the task-specific prompt sentence an instruction to generate multiple alternative content proposals.

11. The system according to claim 1, wherein the generative neural network model comprises a transformer architecture having a plurality of self-attention layers and feed-forward sublayers, and the circuitry is further configured to specify generation parameters including a temperature value, a maximum output length, and a sampling threshold when transmitting the task-specific prompt sentence.

12. The system according to claim 11, wherein the circuitry is further configured to perform post-processing on the generated content data by segmenting the generated content data at delimiter markers, normalizing item names by matching against a dictionary stored in the storage device, and assigning internal identifiers to normalized items.

13. The system according to claim 1, wherein the circuitry is further configured to read, from a storage device, user-specific data comprising history information indicating past interactions and preference information indicating stable attributes of a user associated with the terminal device, and to include the user-specific data in the task-specific prompt sentence so that the generated content data is personalized.

14. The system according to claim 13, wherein the circuitry is further configured to compute a similarity score between the structured output data and reference content records stored in the storage device, and to identify, from stored service provider data, candidate items corresponding to or similar to the structured output data based on the similarity score and availability information.

15. The system according to claim 14, wherein the circuitry is further configured to transmit the candidate items to the terminal device, receive selection confirmation data from the terminal device, generate a fulfillment request comprising an item identifier and an address, transmit the fulfillment request to an external management system via the communication interface, and relay status information received from the external management system to the terminal device.

16. The system according to claim 1, wherein the circuitry is further configured to apply an emotion recognition model to at least one of audio data and image data received from the terminal device to estimate an emotional state, and to include the emotional state in the analysis data used to construct the task-specific prompt sentence.

17. The system according to claim 16, wherein the natural-language input comprises a request relating to a cooking activity, the available resource items comprise foodstuff items stored in a storage apparatus, the target category comprises a type of dish, the preference attribute comprises a taste preference, the structured output data comprises a recipe including a dish name, an ingredient list, and cooking steps, and the generated content data further comprises hidden flavor candidates.

18. A system comprising:
circuitry configured to
receive, via a communication interface coupled to a packet-switched network, a natural-language input and user identification information from a terminal device,
read, from a storage device, user-specific data comprising history information, preference information, and resource inventory data associated with the user identification information,
analyze the natural-language input using a natural language processing method comprising tokenization, part-of-speech tagging, dependency parsing, and intent classification to generate analysis data comprising identified attributes and an intent category,
construct, based on a prompt template selected according to the intent category, a task-specific prompt sentence that integrates the identified attributes, the user-specific data, and the resource inventory data, the task-specific prompt sentence specifying a requested generation task and an output format,
transmit the task-specific prompt sentence to a generative neural network model comprising a transformer architecture and receive generated content data,
convert the generated content data into structured output data by extracting a title field, a resource list field, and a sequential procedure field, and compare the structured output data with reference content records and service provider data stored in the storage device to identify candidate items, and
transmit the structured output data and the candidate items to the terminal device.

19. The system according to claim 18, wherein the circuitry is further configured to compare resource items in the structured output data with the resource inventory data to identify missing resource items, include the missing resource items in a supplemental prompt sentence to obtain substitute candidates and characteristic change explanations from the generative neural network model, and receive, from the terminal device, evaluation feedback to update at least one of the prompt template and generation parameters of the generative neural network model.

20. A method comprising:
receiving, by circuitry via a communication interface coupled to a packet-switched network, a natural-language input from a terminal device;
analyzing the natural-language input using a natural language processing method comprising tokenization, part-of-speech tagging, and dependency parsing to generate analysis data comprising identified attributes including at least a target category, a preference attribute, one or more constraint conditions, and available resource items;
constructing, based on the analysis data, a task-specific prompt sentence that specifies a requested generation task, an output format, and the constraint conditions;
transmitting the task-specific prompt sentence to a generative neural network model and receiving generated content data;
converting the generated content data into structured output data comprising at least a title field, a resource list field, and a sequential procedure field; and
transmitting the structured output data to the terminal device for presentation on a display of the terminal device.
